(19) United States
(12) Patent Application Publication
(10) Pub. No.: US 2026/0095904 A1
(43) Pub. Date: Apr. 2, 2026

(54) MINIMUM TIME GAP FOR LOW POWER-WAKE UP SIGNAL

(71) Applicant: QUALCOMM Incorporated, San Diego, CA (US)

(72) Inventors: Kazuki TAKEDA, Minato-ku (JP); Igor GUTMAN, Hod HaSharon (IL); Tao LUO, San Diego, CA (US); Hemant SAGGAR, San Diego, CA (US)

(21) Appl. No.: 18/905,092

(22) Filed: Oct. 2, 2024

(51) Int. Cl. H04W 72/12; H04W 72/232

(52) U.S. Cl. CPC H04W 72/12; H04W 72/232

(57) ABSTRACT

Methods, systems, and devices for wireless communications are described. A user equipment (UE) may transmit a capability report indicating a capability to support at least a first minimum time gap and a second minimum time gap for physical downlink control channel (PDCCH) monitoring. The UE may receive configuration information that is indicative of a plurality of low power-wakeup signal (LP-WUS) occasions and a plurality of PDCCH monitoring windows. The UE may receive a LP-WUS during a first LP-WUS occasion of the plurality of LP-WUS occasions, and the LP-WUS may be indicative that the UE is to monitor a first PDCCH monitoring window of the plurality of PDCCH monitoring windows, where a time gap between the first LP-WUS occasion and the first PDCCH monitoring window satisfies one of the first minimum time gap or the second minimum time gap. The UE may perform PDCCH monitoring during the first PDCCH monitoring window.

### FIELD OF TECHNOLOGY

The following relates to wireless communications, including a minimum time gap for low power-wakeup signals (LP-WUSs).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include transmitting a capability report indicating a UE capability to support at least a first minimum time gap and a second minimum time gap of a set of multiple candidate minimum time gaps for physical downlink control channel (PDCCH) monitoring, where the first minimum time gap is larger than the second minimum time gap, receiving first configuration information that is indicative of a set of multiple low power-wakeup signal (LP-WUS) occasions and a set of multiple PDCCH monitoring windows, receiving a LP-WUS during a first LP-WUS occasion of the set of multiple LP-WUS occasions, where the LP-WUS is indicative that the UE is to monitor a first PDCCH monitoring window of the set of multiple PDCCH monitoring windows, where a time gap between the first LP-WUS occasion and the first PDCCH monitoring window satisfies one of the first minimum time gap or the second minimum time gap, and performing PDCCH monitoring during the first PDCCH monitoring window.

A UE for wireless communications is described. The UE may include one or more memories storing processor executable code, and one or more processors coupled with the one or more memories. The one or more processors may individually or collectively be operable to execute the code to cause the UE to transmit a capability report indicating a UE capability to support at least a first minimum time gap and a second minimum time gap of a set of multiple candidate minimum time gaps for PDCCH monitoring, where the first minimum time gap is larger than the second minimum time gap, receive first configuration information that is indicative of a set of multiple LP-WUS occasions and a set of multiple PDCCH monitoring windows, receive a LP-WUS during a first LP-WUS occasion of the set of multiple LP-WUS occasions, where the LP-WUS is indicative that the UE is to monitor a first PDCCH monitoring window of the set of multiple PDCCH monitoring windows, where a time gap between the first LP-WUS occasion and the first PDCCH monitoring window satisfies one of the first minimum time gap or the second minimum time gap, and perform PDCCH monitoring during the first PDCCH monitoring window.

Another UE for wireless communications is described. The UE may include means for transmitting a capability report indicating a UE capability to support at least a first minimum time gap and a second minimum time gap of a set of multiple candidate minimum time gaps for PDCCH monitoring, where the first minimum time gap is larger than the second minimum time gap, means for receiving first configuration information that is indicative of a set of multiple LP-WUS occasions and a set of multiple PDCCH monitoring windows, means for receiving a LP-WUS during a first LP-WUS occasion of the set of multiple LP-WUS occasions, where the LP-WUS is indicative that the UE is to monitor a first PDCCH monitoring window of the set of multiple PDCCH monitoring windows, where a time gap between the first LP-WUS occasion and the first PDCCH monitoring window satisfies one of the first minimum time gap or the second minimum time gap, and means for performing PDCCH monitoring during the first PDCCH monitoring window.

A non-transitory computer-readable medium storing code for wireless communications is described. The code may include instructions executable by one or more processors to transmit a capability report indicating a UE capability to support at least a first minimum time gap and a second minimum time gap of a set of multiple candidate minimum time gaps for PDCCH monitoring, where the first minimum time gap is larger than the second minimum time gap, receive first configuration information that is indicative of a set of multiple LP-WUS occasions and a set of multiple PDCCH monitoring windows, receive a LP-WUS during a first LP-WUS occasion of the set of multiple LP-WUS occasions, where the LP-WUS is indicative that the UE is to monitor a first PDCCH monitoring window of the set of multiple PDCCH monitoring windows, where a time gap between the first LP-WUS occasion and the first PDCCH monitoring window satisfies one of the first minimum time gap or the second minimum time gap, and perform PDCCH monitoring during the first PDCCH monitoring window.

In some examples of the method, UEs, and non-transitory computer-readable medium described herein, the time gap satisfies the first minimum time gap and the method, apparatuses, and non-transitory computer-readable medium may include further operations, features, means, or instructions for initializing a power ramp-up of a radio of the UE based on receipt of the LP-WUS in accordance with the first minimum time gap.

In some examples of the method, UEs, and non-transitory computer-readable medium described herein, the time gap satisfies the second minimum time gap, and does not satisfy the first minimum time gap, and where the method may include operations, features, means, or instructions for initializing a power ramp-up of a radio of the UE based on a timing of the first PDCCH monitoring window and continuing the power ramp-up of the radio based on receipt of the LP-WUS in accordance with the second minimum time gap.

In some examples of the method, UEs, and non-transitory computer-readable medium described herein, the time gap satisfies the second minimum time gap, and does not satisfy the first minimum time gap, and where the method may include operations, features, means, or instructions for maintaining a radio of the UE in a power state that may be able to be ramped-up during the second minimum time gap and initializing a power ramp-up of the radio based on receipt of the LP-WUS in accordance with the second minimum time gap.

In some examples of the method, UEs, and non-transitory computer-readable medium described herein, the first configuration information includes one or more parameters that indicate a periodicity associated with the set of multiple PDCCH monitoring windows, an offset associated with start locations of the set of multiple PDCCH monitoring windows, a periodicity associated with the set of multiple LP-WUS occasions, an offset associated with start locations of the set of multiple LP-WUS occasions, or a combination thereof.

In some examples of the method, UEs, and non-transitory computer-readable medium described herein, the first configuration information includes one or more parameters that indicate the first PDCCH monitoring window as a next PDCCH monitoring window after the first LP-WUS occasion such that the time gap satisfies one of the first minimum time gap or the second minimum time gap.

In some examples of the method, UEs, and non-transitory computer-readable medium described herein, the first configuration information includes one or more parameters that indicate the first PDCCH monitoring window such that the first LP-WUS occasion precedes the first PDCCH monitoring window by the time gap in accordance with a rule and the rule defines that the time gap satisfies one of the first minimum time gap or the second minimum time gap.

In some examples of the method, UEs, and non-transitory computer-readable medium described herein, the first configuration information includes one or more parameters that indicate the first LP-WUS occasion such that the first PDCCH monitoring window follows the first LP-WUS occasion by the time gap and the time gap may be one of the one or more parameters and satisfies one of the first minimum time gap or the second minimum time gap.

Some examples of the method, UEs, and non-transitory computer-readable medium described herein may further include operations, features, means, or instructions for receiving, via L1 or L2 signaling, second configuration information that may be indicative of a change in which of the first minimum time gap or the second minimum time gap may be to be satisfied, receiving a second LP-WUS during a second LP-WUS occasion of the set of multiple LP-WUS occasions, where the second LP-WUS may be indicative that the UE may be to monitor a second PDCCH monitoring window of the set of multiple PDCCH monitoring windows, where a second time gap between the second LP-WUS occasion and the second PDCCH monitoring window satisfies one of the first minimum time gap or the second minimum time gap in accordance with the second configuration information, and performing PDCCH monitoring during the second PDCCH monitoring window.

Some examples of the method, UEs, and non-transitory computer-readable medium described herein may further include operations, features, means, or instructions for transmitting a feedback message indicating acknowledgement of the change indicated by the second configuration information.

In some examples of the method, UEs, and non-transitory computer-readable medium described herein, the L1 or L2 signaling includes medium access control-control element (MAC-CE) signaling or downlink control information (DCI) signaling.

In some examples of the method, UEs, and non-transitory computer-readable medium described herein, the first configuration information may be received via radio resource control (RRC) signaling.

Some examples of the method, UEs, and non-transitory computer-readable medium described herein may further include operations, features, means, or instructions for selecting, from among the first minimum time gap and the second minimum time gap, a preferred minimum time gap, where the capability report further indicates the preferred minimum time gap.

In some examples of the method, UEs, and non-transitory computer-readable medium described herein, the preferred minimum time gap may be selected based on a channel condition, a battery power condition of the UE, usage of the UE, or a combination thereof.

Some examples of the method, UEs, and non-transitory computer-readable medium described herein may further include operations, features, means, or instructions for extending the first PDCCH monitoring window such that the first PDCCH monitoring window overlaps, in time, with a next LP-WUS occasion and ramping-up or maintaining a power of a radio of the UE in order to perform PDCCH monitoring during a next PDCCH monitoring window associated with the next LP-WUS occasion, based on the first PDCCH monitoring window overlapping with the next LP-WUS occasion, which prevents the UE from using monitoring the next LP-WUS occasion.

In some examples of the method, UEs, and non-transitory computer-readable medium described herein, the LP-WUS may be received using a first radio of the UE and the PDCCH monitoring may be performed using a second radio of the UE.

In some examples of the method, UEs, and non-transitory computer-readable medium described herein, the first radio may be a LP-WUR of the UE and the second radio may be a main radio of the UE.

Details of one or more implementations of the subject matter described in this disclosure are set forth in the accompanying drawings and the description below.

Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports minimum time gaps for low power-wakeup signals (LP-WUSs) in accordance with one or more aspects of the present disclosure.

FIG. 2 shows an example of a portion of a wireless communications system that supports minimum time gaps for LP-WUSs in accordance with one or more aspects of the present disclosure.

FIGS. 3, 4A, and 4B show example configurations of LP-WUS occasions and PDCCH monitoring windows that support minimum time gaps for LP-WUSs in accordance with one or more aspects of the present disclosure.

FIGS. 5 to 7 show examples of LP-WUS designs that support minimum time gaps for LP-WUSs in accordance with one or more aspects of the present disclosure.

FIG. 8 shows an example of a signal flow that supports minimum time gaps for LP-WUSs in accordance with one or more aspects of the present disclosure.

FIGS. 9 and 10 show block diagrams of devices that support minimum time gaps for LP-WUSs in accordance with one or more aspects of the present disclosure.

FIG. 11 shows a block diagram of a communications manager that supports minimum time gaps for LP-WUSs in accordance with one or more aspects of the present disclosure.

FIG. 12 shows a diagram of a system including a device that supports minimum time gaps for LP-WUSs in accordance with one or more aspects of the present disclosure.

FIG. 13 shows a flowchart illustrating methods that support minimum time gaps for LP-WUSs in accordance with one or more aspects of the present disclosure.

### DETAILED DESCRIPTION

Various aspects of the present disclosure relate to a wireless communication device, such as a user equipment (UE), that implements a low power-wakeup radio (LP-WUR) architecture. The UE that implements the LP-WUR architecture may utilize a LP-WUR to monitor for and receive, from a network entity, such as a base station, one or more physical downlink control channel (PDCCH) messages to support wake up of a main radio (MR) at the UE when the UE operates in a low power mode. For instance, some wireless communication systems may support the use of a LP-WUR at a UE as hardware configured for low power-wakeup signal (LP-WUS) monitoring. As compared to a conventional wireless transceiver (e.g., the MR), the LP-WUR may implement a simpler hardware design, resulting in lower operational power. Accordingly, use of such LP-WURs may substantially reduce overall power consumption at the UE.

In radio resource control (RRC) idle and inactive modes or in an RRC connected state where the UE is in a light or deep sleep, the UE may turn off the MR and switch to the LP-WUR to operate in a low power mode in order to save power. In this low power mode, the UE may use the LP-WUR to monitor for paging early indications (PEI), such as LP-WUSs, from a network entity and the LP-WUSs may serve as an indication of an upcoming PDCCH message (e.g., a paging PDCCH for RRC idle and inactive modes or a data scheduling PDCCH for RRC connected mode) intended for the UE. In this way, the UE may not need to continuously or unnecessarily perform PDCCH monitoring and decoding, which may consume more power than the detection of the LP-WUS, particularly in the cases of sporadic data scheduling.

Accordingly, when one or more data messages, such as one or more physical uplink or downlink shared channel messages, need to be communicated to or from the UE, the UE may first receive a LP-WUS from the network entity and the LP-WUS may trigger the UE to wake up (e.g., to turn on) the MR to monitor for the PDCCH message. In some cases, turning on the MR may require powering up the MR from a sleep state (e.g., a deep sleep state, a light sleep state, a micro sleep state, etc.) to a wake state. To ensure that the MR has sufficient time to perform a transition from a sleep state to a wake state in time to receive an upcoming PDCCH message, in some implementations, the UE may report, to the network entity, a minimum amount of time needed by the UE to perform the transition; and the network entity may configure a time gap between receipt of the LP-WUS and an occasion for monitoring for the PDCCH message accordingly. In some cases, however, the amount of time required by the UE's MR to transition from a sleep state to a wake state may vary based on various factors. For instance, the state of sleep that the MR is in, a battery power condition at the UE, usage of the UE, a capability of the UE, a channel condition, etc. may all play a role in an amount of time required for the MR to perform the transition. As a result, in some instances the UE may require a first minimum amount of time to perform the transition, while in other instances the UE may require a different amount of time to perform the transition. Accordingly, in some cases, it may be advantageous for the UE to report, to the network entity, multiple minimum time gaps that the UE is capable of supporting, and the network entity may make a time gap configuration decision based on the multiple minimum time gaps supported by the UE.

Aspects of the disclosure are initially described in the context of wireless communications systems. Aspects of the disclosure are further illustrated by and described with reference to apparatus diagrams, system diagrams, and flowcharts that relate to minimum time gaps for LP-WUSs.

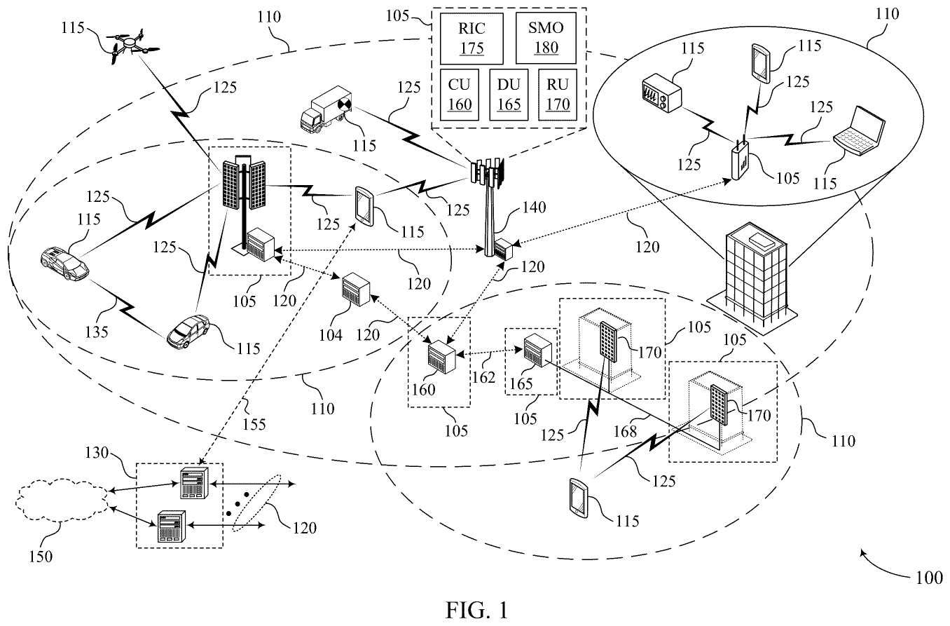

FIG. 1 shows an example of a wireless communications system 100 that supports minimum time gaps for LP-WUSs in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support minimum time gaps for LP-WUSs as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In accordance with aspects described herein, a UE 115 may be configured with a LP-WUR. The UE 115 may utilize the LP-WUR to monitor for and receive one or more signals when the UE 115 operates in a low power mode, such as when a MR of the UE is in a sleep state. For example, the UE 115 may utilize the LP-WUR to monitor for and receive a LP-WUS transmitted by a network entity 105 and targeted for the UE 115. The LP-WUS may be indicative that the UE 115 is to switch from use of the LP-WUR to the MR to receive a PDCCH message. Accordingly, when the UE receives the LP-WUS, the UE may transition its MR from a sleep state to a wake state. The UE 115 may require a minimum amount of time to perform the transition. In some cases, the UE 115 may inform the network entity 105 of the minimum amount of time needed to perform the transition. In this way, the network entity 105, may configure a time gap between transmission of a LP-WUS and an occasion for monitoring for a PDCCH message to ensure that the MR has sufficient time to power up to receive the PDCCH message. In some cases, however, the minimum amount of time needed by the UE may vary depending on one or more conditions associated with the UE 115 or with a channel used by the UE 115. Accordingly, in some implementations, the UE 115 may report, to the network entity 105, multiple minimum time gaps that the UE 115 is capable of supporting, and the network entity 105 may make a time gap configuration decision based on the multiple minimum time gaps supported by the UE 115.

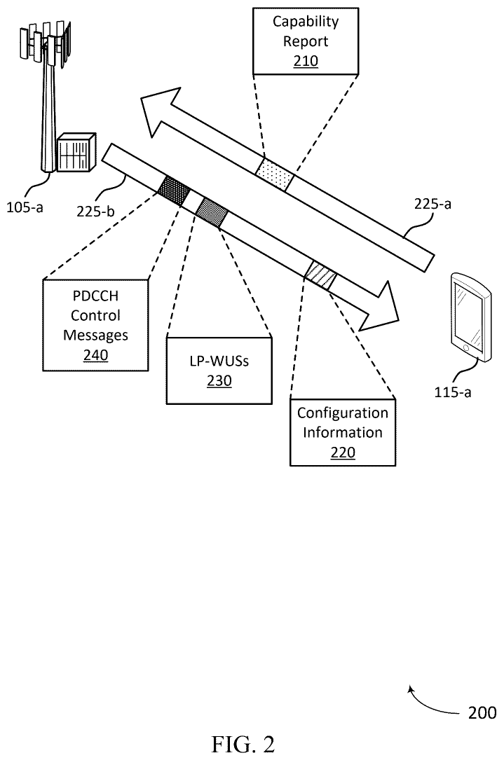

FIG. 2 shows an example of a portion of a wireless communications system 200 that supports minimum time gaps for LP-WUSs in accordance with one or more aspects of the present disclosure. In some cases, the wireless communications system 200 may support or be supported by aspects of the wireless communications system 100 described with reference to FIG. 1. For instance, the wireless communications system 200 may include a network entity 105-a and a UE 115-a, which may be examples of network entities 105 and UEs 115, respectively, described with reference to FIG. 1. The network entity 105-a and UE 115-a may communicate using communication links 225 (e.g., communication links 225-a and 225-b), which may be examples of the communication links 125 described with reference to FIG. 1.

For instance, in accordance with aspects described herein, the UE 115-a may transmit, and the network entity 105-a may receive, uplink communications, such as a capability report 210, via an uplink communication link 225-a. In accordance with aspects described herein, the capability report may indicate a capability of the UE 115-a to support multiple minimum time gaps. For example, the capability report 210 may indicate multiple minimum time gap values supported by the UE 115-a. In some examples, the capability report 210 may additionally indicate a preference for a particular one of the multiple minimum time gap values.

In response to receiving the capability report 210, the network entity 105-a may transmit via a downlink communication link 225-b, and the UE 115-a may receive, downlink communications, such as configuration information 220, one or more LP-WUSs 230, or one or more PDCCH control messages 240. In accordance with aspects described herein, the configuration information 220 may include an indication of plurality of LP-WUS occasions to be monitored for receiving the one or more LP-WUSs 230 and a plurality of PDCCH monitoring windows to be monitored for receiving the one or more PDCCH control messages 240. The plurality of LP-WUS occasions and the plurality of PDCCH monitoring windows may be configured based on one or more of the supported multiple minimum time gaps, such that a time gap between a LP-WUS and a next PDCCH monitoring window satisfies the one or more of the supported multiple minimum time gaps used by the network entity 105-a. In some cases, the configuration information may additionally include one or more parameters that indicate a periodicity associated with the plurality of PDCCH monitoring windows or with the plurality of LP-WUS occasions, an offset associated with start locations of the plurality of PDCCH monitoring windows or with start locations of the plurality of LP-WUS occasions, or a combination thereof.

In some cases, the configuration information may include an indication of a rule that the UE 115-a may use to determine which of the plurality of LP-WUS occasions the UE 115-a should monitor for the LP-WUS 230, and the rule may be based on one or more of the supported multiple minimum time gaps. In some cases, the configuration information may include an indication of one or more of the supported multiple minimum time gaps that were selected by the network entity 105-a for configuring the plurality of LP-WUS occasions and the plurality of PDCCH monitoring windows. In some cases, the configuration information may include an indication of a switch in which of the one or more supported multiple minimum time gaps is used by the network entity 105-a to configure the plurality of LP-WUS occasions and the plurality of PDCCH monitoring windows (e.g., a switch in a time gap configured between a LP-WUS and a next PDCCH monitoring window). In some cases, the configuration information may include an indication of an extension of one or more of the plurality of PDCCH monitoring windows to accommodate PDCCH traffic during the PDCCH monitoring window.

The network entity 105-a may, thereafter, transmit, and the UE 115-a may receive, one or more LP-WUSs 230. The one or more LP-WUSs 230 may be an indication that the UE 115-a is to wake up its MR to receive a PDCCH control message 240. Accordingly, upon receipt of one of the LP-WUSs 230, the UE 115-a may power-up its MR in order to monitor a PDCCH monitoring window for the PDCCH control message 240. The PDCCH monitoring windows may be configured such that a time gap between receipt of the LP-WUS 230 and a next PDCCH monitoring window satisfies one or more of the supported minimum time gap values, and the UE 115-a may, thus, have sufficient time to transition to its MR to receive the PDCCH control message 240 during the next PDCCH monitoring window.

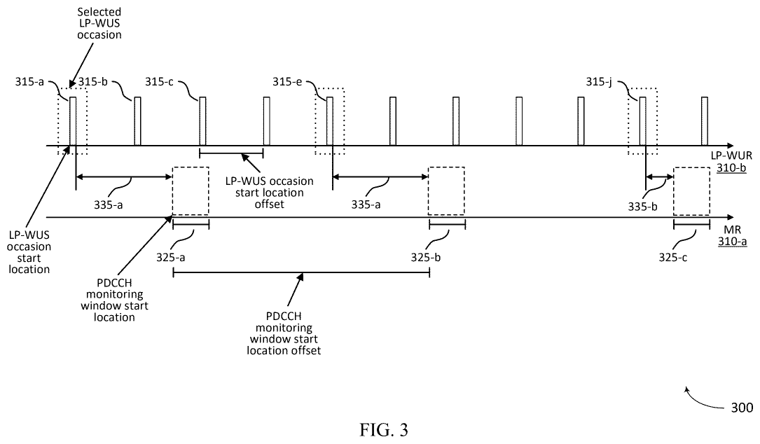

FIG. 3 shows an example time gap configuration 300 including a configuration of LP-WUS occasions and PDCCH monitoring windows that supports minimum time gaps for LP-WUSs in accordance with one or more aspects of the present disclosure. In some aspects, time gap configuration 300 may be implemented by aspects of the wireless communications systems 100 and 200, as described with reference to FIGS. 1 and 2. For example, network entity 105-a, UE 115-a, or a combination thereof, may be configured to operate in accordance with the time gap configuration 300. In some aspects, the UE 115-a may be configured with a LP-WUR, and the time gap configuration 300 may support the use of the LP-WUR at the UE 115-a for LP-WUS monitoring.

In some implementations, the UE 115-a may operate in a low power mode with a first radio, such as a MR 310-a, in and OFF state (e.g., a sleep state) and with a second radio, such as a LP-WUR 310-b, in an ON state (e.g., a wake state). The UE 115-a may utilize the LP-WUR 310-b to monitor for and receive one or more LP-WUSs, such as the one or more LP-WUSs 230 of FIG. 2, when the UE 115-a operates in the low power mode. The one or more LP-WUSs 230 may be indicative that the UE 115-a is to switch from use of the LP-WUR 310-b to the MR 310-a to receive one or more PDCCH control messages, such as the one or more PDCCH control messages 240 of FIG. 2. Accordingly, when the UE 115-a receives a LP-WUS 230, the UE 115-a may transition its MR 310-a from a sleep state to a wake state. The UE 115-a may require a minimum amount of time to perform the transition. In some cases, the UE 115-a may inform the network entity 105-a of the minimum amount of time needed to perform the transition. In this way, the network entity 105-a, may configure a time gap between transmission of a LP-WUS 230 and an occasion for monitoring for a PDCCH control message 240 to ensure that the MR 310-a has sufficient time to power up to receive the PDCCH control message 240. In some cases, however, the minimum amount of time needed by the UE 115-a may vary depending on one or more conditions associated with the UE 115-a (e.g., a capability of the UE 115-a, a usage at the UE 115-a, a battery condition associated with the UE 115-a, a sleep state of the MR 310-a, or the like) or with a channel used by the UE 115-a to communicate with the network entity 105-a.

In accordance with aspects described herein, to assist the network entity 105-a in configuring one or more LP-WUS occasions and one or more PDCCH monitoring windows, such that there is a time gap between transmission of a LP-WUS 230 and a next PDCCH monitoring window that is sufficient for the MR 310-a to wake in time to begin monitoring the next PDCCH monitoring window for the PDCCH control message 240, the UE 115-a may report, to the network entity 105-a, multiple minimum time gaps that the UE 115-a is capable of supporting. For instance, the UE 115-a may transmit to the network entity 105-a a capability report, such as the capability report 210 of FIG. 2, that indicates a capability of the UE 115-a to support one or more minimum time gap values. In some cases, the one or more supported minimum time gap values may be selected from a plurality of candidate minimum time gap values. By way of example, the capability report 210 may include an indication of two supported minimum time gap values (although the capability report 210 may not be limited to two supported minimum time gap values and may instead include more than two supported minimum time gap values). For instance, the capability report 210 may include an indication of a first supported minimum time gap value and of a second supported minimum time gap value, where the first supported minimum time gap value may be greater than the second supported minimum time gap value (e.g., the first supported minimum time gap value=10 ms and the second supported minimum time gap value=3 ms).

In some cases, the UE 115-a may include in the capability report 210 a preference for a particular one of the supported multiple minimum time gap values. For instance, the UE 115-a may select, based on one or more conditions associated with the UE 115-a (e.g., a capability of the UE 115-a, a usage at the UE 115-a, a battery condition associated with the UE 115-a, a sleep state of the MR 310-a, or the like) or with a channel used by the UE 115-a, a particular one of the supported multiple minimum time gap values that the UE 115-a prefers, and may indicate the preferred minimum time gap value in the capability report 210. In some cases, the UE 115-a may indicate the preferred minimum time gap value in an additional, separate capability report that is reported to the network entity 105-a at a time after transmission of the capability report 210. The additional capability report may cause the network entity to adjust one or more parameters associated with an existing configuration. The capability report 210 or the additional capability report may be signaled to the network entity 105-a via UE assistance information, a medium access control-control element (MAC-CE), uplink information, or other control signaling.

In response to receiving the capability report 210 (or the additional capability report), the network entity 105-a may configure a plurality of LP-WUS occasions 315 (e.g., such as a first LP-WUS occasions 315-a, a second LP-WUS occasion 315-b, a third LP-WUS occasion 315-c, etc.) and a plurality of PDCCH monitoring windows (e.g., such as a first PDCCH monitoring windows 325-a, a second PDCCH monitoring windows 325-b, a third PDCCH monitoring windows 325-c, etc.). The network entity 105-a may configure the plurality of LP-WUS occasions 315 and the plurality of PDCCH monitoring windows 325 based on one or more of the multiple minimum time gaps supported by the UE 115-a and indicated in the capability report 210 (or the additional capability report).

For instance, the network entity 105-a may configure resources associated with the plurality of PDCCH monitoring windows 325 and the plurality of LP-WUS occasions 315. The network entity 105-a may additionally configure one or more parameters that indicate a periodicity associated with the plurality of PDCCH monitoring windows 325, an offset associated with start locations of the plurality of PDCCH monitoring windows 325, a periodicity associated with the plurality of LP-WUS occasions 315, and an offset associated with start locations of the plurality of LP-WUS occasions 315. In some examples, the PDCCH monitoring window periodicity and offsets may be configured via a connected mode discontinuous reception (C-DRX) operation configured by RRC parameters drx-LongCycleStartOffset and drx-SlotOffset), and the LP-WUS occasion periodicity and offsets may be configured by RRC parameters LP-WUS-periodicity and LP-WUS-offset. In some cases, the configuration of the plurality of PDCCH monitoring windows 325, the plurality of LP-WUS occasions 315, and the one or more parameters may be referred to herein collectively as a time gap configuration.

The network entity 105-a may configure the one or more parameters such that a time gap 335 (e.g., large time gap 335-a or short time gap 335-b) between a LP-WUS occasion 315 and a start of a PDCCH monitoring window 325, such as a start of a next PDCCH monitoring window 325 after the LP-WUS occasion 315, satisfies one or more of the supported multiple minimum time gap values. The network entity 105-a may determine which of the one or more supported multiple minimum time gap values is to be satisfied based on a rule associated with the time gap 335.

For instance, in some cases, such as when the capability report 210 includes an indication of the first supported minimum time gap value and the second supported minimum time gap value, the network entity 105-a may utilize a first time gap rule that indicates that the one or more parameters are to be configured such that the time gap 335 (between a LP-WUS occasion 315 and a start of a PDCCH monitoring window 325) is to be greater than the first supported minimum time gap value. Use of the first time gap rule may result in a large time gap 335-a and may be utilized by the network entity 105-a when power savings is prioritized. In other cases, such as when the capability report 210 includes an indication of the first supported minimum time gap value and the second supported minimum time gap value, the network entity 105-a may utilize a second time gap rule that indicates that the one or more parameters are to be configured such that the time gap 335 (between a LP-WUS occasion 315 and a start of a PDCCH monitoring window 325) is to be less than the first supported minimum time gap value and greater than the second supported minimum time gap value. Use of the second time gap rule may result in a short time gap 335-b and may be utilized by the network entity 105-a when low-latency for ramp-up of the MR 310-a of the UE 115-a is prioritized. In other cases, such as when the capability report 210 (or the additional capability report) includes an indication of the preferred minimum time gap value, the network entity 105-a may utilize a third time gap rule that indicates that the one or more parameters are to be configured such that the time gap 335 (between a LP-WUS occasion 315 and a start of a PDCCH monitoring window 325) is to be less than the preferred minimum time gap value. Use of the third time gap rule may ensure that conditions at the UE 115-a or a channel associated with the UE 115-a are taken into account when the one or more parameters are configured by the network entity 105-a.

In some implementations, the time gap configuration may be semi-statically signaled to the UE 115-a. For instance, the network entity 105-a may transmit to the UE 115-a, via RRC signaling, configuration information that indicates the plurality of LP-WUS occasions 315, the plurality of PDCCH monitoring windows 325, and the one or more parameters (e.g., one or more RRC parameters). In some cases, the configuration information may additionally include an indication of the time gap rule (e.g., the first time gap rule, the second time gap rule, or the third time gap rule) used by the network entity 105-a for configuring the time gap configuration. In some cases, the configuration information may include an indication of which of the one or more of the supported multiple minimum time gap values is effective (e.g., is satisfied) (e.g., the first supported minimum time gap value, the second supported minimum time gap value, or the preferred minimum time gap value). In some cases, the configuration information may include an indication of the time gap 335 that is effective (e.g., the large time gap 335-a or the short time gap 335-b).

In some cases, the network entity 105-a may determine to switch between a large time gap 335-a and short time gap 335-b (or visa versa) (in some cases this may be triggered by receipt of the additional capability report or second capability report 210). In some cases, the network entity 105-a may signal updated configuration information to the UE 115-a based on an RRC re-configuration to effectuate the switch between time gaps 335. In other cases, the network entity 105-a may signal the switch between the time gaps 335 via L1 or L2 signaling. For instance, the L1/L2 signaling may be MAC-CE, DCI format, etc. For instance, while the plurality of LP-WUS occasions 315 and the plurality of PDCCH monitoring windows 325 may be configured based on RRC configuration (e.g., as previously described), the L1/L2 signaling may be utilized to dynamically indicate to the UE 115-a which of the time gaps 335—the large time gap 335-a or the short time gap 335-b—is currently effective (or in some cases, which of the time gap rules is effective). After receiving the L1/L2 signaling, in some cases, the UE 115-a may send an acknowledgement message (e.g., HARQ-ACK) acknowledging successful receipt of the L1/L2 signaling indicating the switch to the currently effective time gap 335. The UE 115-a may process the switch to the currently effective time gap 335 beginning at a particular one of the LP-WUS occasions 315 (e.g., indicated by the L1/L2 signaling). As an example, the UE 115-a may process the switch to the currently effective time gap 335 beginning at a first LP-WUS occasion 315 that is 3 ms after a time that the UE 115-a acknowledges the L1/L2 signalling.

The UE 115-a may receive, from the network entity 105-a, the RRC signaling including the configuration information or the L1/L2 signaling including the dynamic indication of a switch from one time gap 335 to a currently effective time gap 335. In some cases, the UE 115-a may select which of the plurality of LP-WUS occasions 315 to monitor for a LP-WUS 230 based on the time gap rule or the time gap 335 (e.g., the large time gap 335-a or the short time gap 335-b) indicated in the configuration information. By way of first example, when the first time gap rule is indicated (or similarly when the large time gap 335-a is indicated), the UE 115-a may select LP-WUS occasions 315-a and 315-e to monitor. By way of a second example, when the second time gap rule is indicated (or similarly when the short time gap 335-b is indicated), the UE 115-a may select the LP-WUS occasion 315-j to monitor. Because the network entity 105-a may be aware of the configured time gap rule indicated in the configuration information, the network entity 105-a may be able to identify the LP-WUS occasions 315 that the UE 115-a actually monitors for the LP-WUS 230.

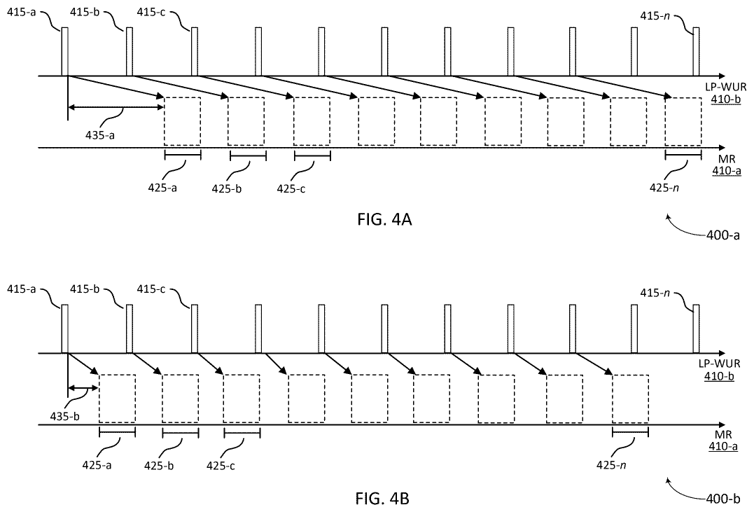

FIGS. 4A and 4B show example time gap configurations 400-a and 400-b including configurations of LP-WUS occasions and PDCCH monitoring windows that support minimum time gaps for LP-WUSs in accordance with one or more aspects of the present disclosure. In some aspects, time gap configurations 400-a and 400-b may be implemented by aspects of the wireless communications systems 100 and 200, as described with reference to FIGS. 1 and 2, and time gap configuration 300, as described with reference to FIG. 3. For example, network entity 105-a, UE 115-a, or a combination thereof, may be configured to operate in accordance with the time gap configurations 400-a and 400-b. In some aspects, the UE 115-a may be configured with a LP-WUR, and the time gap configurations 400-a and 400-b may support the use of the LP-WUR at the UE 115-a for LP-WUS monitoring.

In some implementations, the UE 115-a may operate in a low power mode with a first radio, such as a MR 410-a, in and OFF state (e.g., a sleep state) and with a second radio, such as a LP-WUR 410-b, in an ON state (e.g., a wake state). The UE 115-a may utilize the LP-WUR 410-b to monitor one or more of a plurality of LP-WUS occasions 415 (e.g., a first LP-WUS occasion 415-a, a second LP-WUS occasion 415-b, a third LP-WUS occasion 415-c, an nth LP-WUS occasion 415-n, etc.) for receiving one or more LP-WUSs 230, when the UE 115-a operates in the low power mode. The one or more LP-WUSs 230 may be indicative that the UE 115-a is to switch from use of the LP-WUR 410-b to the MR 410-a to monitor one or more of a plurality of PDCCH monitoring windows 425 (e.g., a first PDCCH monitoring window 425-a, a second PDCCH monitoring window 425-b, a third PDCCH monitoring window 425-c, . . . an nth PDCCH monitoring window 425-n.) for receiving the one or more PDCCH control messages 240. Accordingly, when the UE 115-a receives a LP-WUS 230, the UE 115-a may transition its MR 410-a from a sleep state to a wake state. The UE 115-a may require a minimum amount of time to perform the transition. In some cases, the UE 115-a may require different amounts of time to perform the transition based on conditions at the UE 115-a or on conditions of a channel over which the UE 115-a communicates. In order to assist the network entity 105-a in configuring the plurality of LP-WUS occasions 415 and the plurality of PDCCH monitoring windows 425, such that there is a time gap between transmission of a LP-WUS 230 during one of the LP-WUS occasions 415 and a next PDCCH monitoring window 425 that is sufficient for the MR 410-a to wake in time to begin monitoring the next PDCCH monitoring window 425 for the PDCCH control message 240, the UE 115-a may report, to the network entity 105-a, multiple minimum time gap values that the UE 115-a is capable of supporting.

Accordingly, the network entity 105-a may configure the plurality of LP-WUS occasions 415, the plurality of PDCCH monitoring windows 425, and one or more parameters indicating a periodicity associated with the plurality of LP-WUS occasions 415, an offset associated with start locations of the plurality of LP-WUS occasions 415, or a combination thereof, such that a time gap 435 (between a LP-WUS occasion 415 and a start of a PDCCH monitoring window 425) satisfies one or more of the multiple supported minimum time gap values. In some cases, the configuration of the plurality of LP-WUS occasions 415, the plurality of PDCCH monitoring windows 425, and one or more parameters may be referred to herein collectively as a time gap configuration.

In some implementations, the time gap configuration may be semi-statically signaled to the UE 115-a. For instance, the network entity 105-a may transmit, to the UE 115-a via RRC signaling, configuration information that indicates the plurality of LP-WUS occasions 415, the plurality of PDCCH monitoring windows 425, and the one or more parameters (e.g., one or more RRC parameters). In some cases, the configuration information may additionally include an indication of a time gap rule (e.g., the first time gap rule, the second time gap rule, or the third time gap rule, as described with reference to FIG. 3) used by the network entity 105-a for configuring the time gap configuration. In some cases, the configuration information may include an indication of which of one or more multiple minimum time gap values supported by the UE 115-a is effective (e.g., the first supported minimum time gap value, the second supported minimum time gap value, or the preferred minimum time gap value, as described with reference to FIG. 3). In some cases, the configuration information may include an indication of the time gap 435 that is effective (e.g., a large time gap 435-a or a short time gap 435-b). In some cases, the network entity 105-a may dynamically signal to the UE 115-a, via L1/L2 signaling, a currently effective time gap 435 (or a time gap rule used to effectuate the time gap 435). For instance, the network entity 105-a may indicate via the L1/L2 signaling a switch from one time gap 435 to another time gap 435 (e.g., from a large time gap 435-a to a short time gap 435-b or vice versa).

The UE 115-a may receive, from the network entity 105-a, the RRC signaling including the configuration information or the L1/L2 signaling including the dynamic indication of the currently effective time gap 435 (or time gap rule). In some implementations, rather than indicating starting locations of the plurality of PDCCH monitoring windows 425 in the RRC-signaled configuration information (such as described with reference to FIG. 3), the starting locations of the plurality of PDCCH monitoring windows 425 may, instead, be determined based on the time gap 435 (or a corresponding time gap rule) indicated in the configuration information or the L1/L2 signaling. For instance, referring to FIG. 4A, in some cases, the plurality of monitoring windows 425 may be determined based on the large time gap 435-a (or the corresponding time gap rule, e.g., the first time gap rule) indicated in the configuration information or the L1/L2 signaling. Referring to FIG. 4B, in some cases, the plurality of monitoring windows 425 may be determined based on the short time gap 435-b (or the corresponding time gap rule, e.g., the second time gap rule) indicated in the configuration information or the L1/L2 signaling.

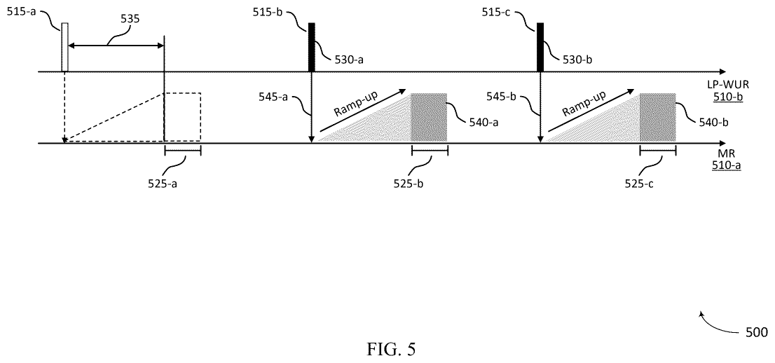

FIG. 5 shows an example of a LP-WUS design 500 that supports minimum time gaps for LP-WUSs in accordance with one or more aspects of the present disclosure. In some aspects, the LP-WUS design 500 may be implemented by aspects of the wireless communications systems 100 and 200, as described with reference to FIGS. 1 and 2, and time gap configurations 300, 400-a, and 400-b, as described with reference to FIGS. 3, 4A, and 4B. For example, network entity 105-a, UE 115-a, or a combination thereof, may be configured to operate in accordance with the LP-WUS design 500. In some aspects, the UE 115-a may be configured with a LP-WUR, and the LP-WUS design 500 may support the use of the LP-WUR at the UE 115-a for LP-WUS monitoring.

Accordingly, the UE 115-a may operate in a low power mode with a first radio, such as a MR 510-a, in and OFF state (e.g., a sleep state) and with a second radio, such as a LP-WUR 510-b, in an ON state (e.g., a wake state). The UE 115-a may utilize the LP-WUR 510-b to monitor one or more of a plurality of LP-WUS occasions 515 (e.g., a first LP-WUS occasion 515-a, a second LP-WUS occasion 515-b, a third LP-WUS occasion 515-c, etc.) for receiving one or more LP-WUSs 530 (e.g., a first LP-WUS 530-a, a second LP-WUS 530-b, etc.), when the UE 115-a operates in the low power mode. The one or more LP-WUSs 530 may be indicative that the UE 115-a is to switch from use of the LP-WUR 510-b to the MR 510-a to monitor one or more of a plurality of PDCCH monitoring windows 525 (e.g., a first PDCCH monitoring window 525-a, a second PDCCH monitoring window 525-b, a third PDCCH monitoring window 525-c, etc.) for receiving the one or more PDCCH control messages 540 (e.g., a first PDCCH control message 540-a, a second PDCCH control message 540-b, etc.). For instance, the LP-WUSs 530 may provide corresponding wake-up indications 545 (e.g., a first wake-up indication 545-a, a second wake-up indication 545-b, etc.) to the UE 115-a. Accordingly, when the UE 115-a detects a LP-WUS 530 and receives a corresponding wake-up indication 545, the UE 115-a may transition its MR 510-a from a sleep state to a wake state.

The plurality of LP-WUS occasions 515 and the plurality of PDCCH monitoring windows 525 may be configured by the network entity 105-a to satisfy one or more of multiple minimum time gap values supported by the UE 115-a and reported to the network entity 105-a via capability reporting (such as described with reference to FIGS. 2, 3, 4A, and 4B). For example, the plurality of LP-WUS occasions 515 and the plurality of PDCCH monitoring windows 525 may be configured such that a time gap 535 (between a LP-WUS occasion 515 and a start of a PDCCH monitoring window 525) satisfies one or more of the supported multiple minimum time gap values. The network entity 105-a may determine which of the one or more supported multiple minimum time gap values is to be satisfied based on a rule associated with the time gap 535 (e.g., the first time gap rule, the second time gap rule, or the third time gap rule, described with reference to FIG. 3). By way of example, the UE 115-a may have reported a first supported minimum time gap value and a second supported minimum time gap value (such as described with reference to FIGS. 3, 4A, and 4b) to the network entity 105-a, and the network entity may have configured the time gap 535, as a large time gap, based on the first rule (e.g., where the time gap 535 is greater than the first supported minimum time gap value). In this case, the UE 115-a may ignore or not monitor any LP-WUS occasion 515 that has a time gap between the LP-WUS occasion 515 and a start of a next PDCCH monitoring window 525 that does not satisfy the first rule (e.g., where the time gap is not greater than the first supported minimum time gap value).

Accordingly, the UE 115-a may use the LP-WUR 510-b to monitor the plurality of LP-WUS occasions 515 for one or more LP-WUSs 530. The UE 115-a may detect a first LP-WUS 530-a during the second LP-WUS occasion 515-b. The first LP-WUS 530-a may trigger the UE 115-a to receive the first wake-up indication 545-a, which may cause the UE 115-a to ramp-up power of the MR 510-a to transition the MR 510-a from a sleep state, such as a deep sleep state, to a wake state, during the time gap 535. Accordingly, the UE 115-a may have sufficient time to transition the MR 510-a to the wake state in order to monitor the next PDCCH monitoring window 525-b using the MR 510-a. Accordingly, the UE 115-a may receive, using the MR 510-a and during the PDCCH monitoring window 525-b, a PDCCH control message 540-a. In some cases, after the PDCCH monitoring window 525-b ends, the UE 115-a may ramp-down power of the MR 510-a to transition the MR 510-a back to the sleep state. The UE 115-a may then use the LP-WUR 510-b to monitor for further LP-WUSs 530.

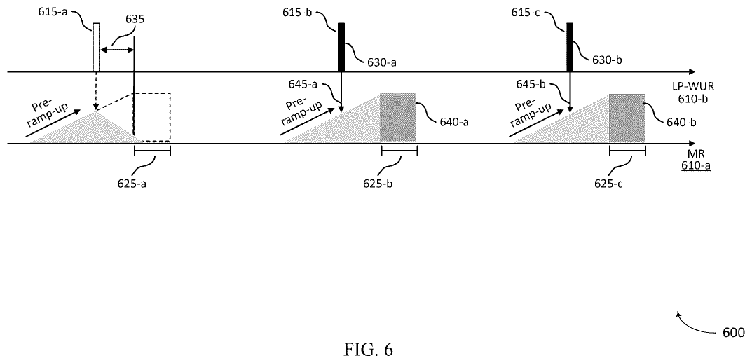

FIG. 6 shows an example of a LP-WUS design 600 that supports minimum time gaps for LP-WUSs in accordance with one or more aspects of the present disclosure. In some aspects, the LP-WUS design 600 may be implemented by aspects of the wireless communications systems 100 and 200, as described with reference to FIGS. 1 and 2, time gap configurations 300, 400-a, and 400-b, as described with reference to FIGS. 3, 4A, and 4B, and LP-WUS design 500, as described with reference to FIG. 5. For example, network entity 105-a, UE 115-a, or a combination thereof, may be configured to operate in accordance with the LP-WUS design 600. In some aspects, the UE 115-a may be configured with a LP-WUR, and the LP-WUS design 600 may support the use of the LP-WUR at the UE 115-a for LP-WUS monitoring.

Accordingly, the UE 115-a may operate in a low power mode with a first radio, such as a MR 610-a, in and OFF state (e.g., a sleep state) and with a second radio, such as a LP-WUR 610-b, in an ON state (e.g., a wake state). The UE 115-a may utilize the LP-WUR 610-b to monitor one or more of a plurality of LP-WUS occasions 615 (e.g., a first LP-WUS occasion 615-a, a second LP-WUS occasion 615-b, a third LP-WUS occasion 615-c, etc.) for receiving one or more LP-WUSs 630 (e.g., a first LP-WUS 630-a, a second LP-WUS 630-b, etc.), when the UE 115-a operates in the low power mode. The one or more LP-WUSs 630 may be indicative that the UE 115-a is to switch from use of the LP-WUR 610-b to the MR 610-a to monitor one or more of a plurality of PDCCH monitoring windows 625 (e.g., a first PDCCH monitoring window 625-a, a second PDCCH monitoring window 625-b, a third PDCCH monitoring window 625-c, etc.) for receiving the one or more PDCCH control messages 640 (e.g., a first PDCCH control message 640-a, a second PDCCH control message 640-b, etc.). For instance, the LP-WUSs 630 may provide corresponding wake-up indications 645 (e.g., a first wake-up indication 645-a, a second wake-up indication 645-b, etc.) to the UE 115-a. Accordingly, when the UE 115-a detects a LP-WUS 630 and receives a corresponding wake-up indication 645, the UE 115-a may transition its MR 610-a from a sleep state to a wake state.

The plurality of LP-WUS occasions 615 and the plurality of PDCCH monitoring windows 625 may be configured by the network entity 105-a to satisfy one or more of multiple minimum time gap values supported by the UE 115-a and reported to the network entity 105-a via capability reporting (such as described with reference to FIGS. 2, 3, 4A, and 4B). For example, the plurality of LP-WUS occasions 615 and the plurality of PDCCH monitoring windows 625 may be configured such that a time gap 635 (between a LP-WUS occasion 615 and a start of a PDCCH monitoring window 625) satisfies one or more of the supported multiple minimum time gap values. The network entity 105-a may determine which of the one or more supported multiple minimum time gap values is to be satisfied based on a rule associated with the time gap 635 (e.g., the first time gap rule, the second time gap rule, or the third time gap rule, described with reference to FIG. 3). By way of example, the UE 115-a may have reported a first supported minimum time gap value and a second supported minimum time gap value (such as described with reference to FIGS. 3, 4A, and 4b) to the network entity 105-a, and the network entity may have configured the time gap 635, as a short time gap, based on the second rule (e.g., where the time gap 535 is less than the first supported minimum time gap value and greater than the second supported minimum time gap value). In this case, the UE 115-a may ignore or not monitor any LP-WUS occasion 615 that has a time gap between the LP-WUS occasion 615 and a start of a next PDCCH monitoring window 625 that does not satisfy the second rule (e.g., where the time gap is not less than the first supported minimum time gap value or is not greater than the second supported minimum time gap value).

In some cases, because the time gap 635 may be a short time gap, the UE 115-a may need to ramp-up the power of the MR 610-a prior to receipt of the LP-WUS 530 or may need to maintain a state of the MR 610-a in a light-sleep state that may enable a quick ramp-up of power of the MR 610-a. Accordingly, the UE 115-a may use the LP-WUR 610-b to monitor the plurality of LP-WUS occasions 615 for one or more LP-WUSs 630. The UE 115-a may, during a time prior to a start of a LP-WUS occasion 615, such as prior to a start of the first LP-WUS occasion 615-a, perform an early ramp-up (e.g., a pre-ramp-up) of power of the MR 610-a. The early ramp-up may begin a process of transitioning the MR 610-a from a sleep state, such as a deep sleep state, to a wake state, such that by a time of a start of the first LP-WUS occasion 615-a, the power of the MR 610-a may have, at least partially, been ramped-up (e.g., may have been ramped-up to a light sleep state). At the start of the first LP-WUS occasion 615-a, the UE 115-a may monitor for a LP-WUS 630. If the UE 115-a does not detect a LP-WUS 630 during the LP-WUS occasion 615-a, the UE 115-a may ramp down power of the MR 610-a from the light sleep state back to the deep sleep state.

Thereafter, the UE 115-a may, during a time prior to a start of the second LP-WUS occasion 615-b, perform an early ramp-up (e.g., a pre-ramp-up) of power of the MR 610-a. The early ramp-up may begin a process of transitioning the MR 610-a from the deep sleep state to a wake state, such that by a time of a start of the second LP-WUS occasion 615-b, the power of the MR 610-a may have been ramped-up to a light sleep state. At the start of the second LP-WUS occasion 615-a, the UE 115-a may monitor for a LP-WUS 630 and may detect a first LP-WUS 630-a during the second LP-WUS occasion 615-b. The first LP-WUS 630-a may trigger the UE 115-a to receive the first wake-up indication 645-a, which may cause the UE 115-a to continue to ramp-up power of the MR 610-a, such as to transition the MR 610-a from the light sleep state to a wake state, during the time gap 635. Accordingly, the UE 115-a may have sufficient time to transition the MR 610-a to the wake state in order to monitor the next PDCCH monitoring window 625-b using the MR 610-a. Accordingly, the UE 115-a may receive, using the MR 610-a and during the PDCCH monitoring window 625-b, a PDCCH control message 640-a. In some cases, after the PDCCH monitoring window 625-b ends, the UE 115-a may ramp-down power of the MR 610-a to transition the MR 610-a back to the sleep state. The UE 115-a may then use the LP-WUR 610-b to monitor for further LP-WUSs 630.

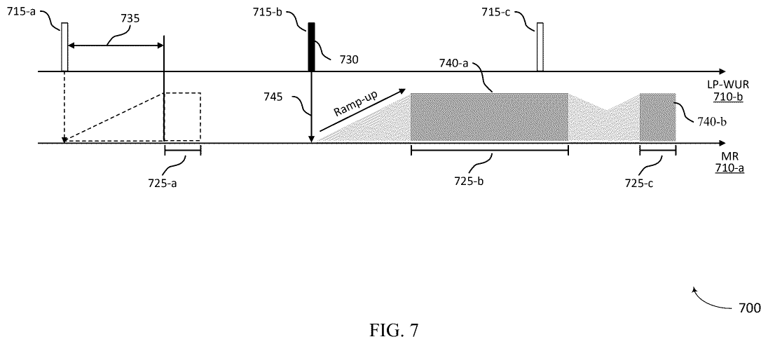

FIG. 7 shows an example of a LP-WUS design 700 that supports minimum time gaps for LP-WUSs in accordance with one or more aspects of the present disclosure. that supports minimum time gaps for LP-WUSs in accordance with one or more aspects of the present disclosure. In some aspects, the LP-WUS design 700 may be implemented by aspects of the wireless communications systems 100 and 200, as described with reference to FIGS. 1 and 2, time gap configurations 300, 400-a, and 400-b, as described with reference to FIGS. 3, 4A, and 4B, and LP-WUS designs 500 and 600, as described with reference to FIGS. 5 and 6. For example, network entity 105-a, UE 115-a, or a combination thereof, may be configured to operate in accordance with the LP-WUS design 700. In some aspects, the UE 115-a may be configured with a LP-WUR, and the LP-WUS design 700 may support the use of the LP-WUR at the UE 115-a for LP-WUS monitoring.

Accordingly, the UE 115-a may operate in a low power mode with a first radio, such as a MR 710-a, in and OFF state (e.g., a sleep state) and with a second radio, such as a LP-WUR 710-b, in an ON state (e.g., a wake state). The UE 115-a may utilize the LP-WUR 710-b to monitor one or more of a plurality of LP-WUS occasions 715 (e.g., a first LP-WUS occasion 715-a, a second LP-WUS occasion 715-b, a third LP-WUS occasion 715-c, etc.) for receiving one or more LP-WUSs 730, when the UE 115-a operates in the low power mode. The one or more LP-WUSs 730 may be indicative that the UE 115-a is to switch from use of the LP-WUR 710-b to the MR 710-a to monitor one or more of a plurality of PDCCH monitoring windows 725 (e.g., a first PDCCH monitoring window 725-a, a second PDCCH monitoring window 725-b, a third PDCCH monitoring window 725-c, etc.) for receiving the plurality of PDCCH control messages 740 (e.g., a first PDCCH control message 740-a, a second PDCCH control message 740-b, etc.). For instance, the LP-WUSs 730 may provide corresponding wake-up indications 745 to the UE 115-a. Accordingly, when the UE 115-a detects a LP-WUS 730 and receives a corresponding wake-up indication 745, the UE 115-a may transition its MR 710-a from a sleep state to a wake state.

The plurality of LP-WUS occasions 715 and the plurality of PDCCH monitoring windows 725 may be configured by the network entity 105-a to satisfy one or more of multiple minimum time gap values supported by the UE 115-a and reported to the network entity 105-a via capability reporting (such as described with reference to FIGS. 2, 3, 4A, and 4B). For example, the plurality of LP-WUS occasions 715 and the plurality of PDCCH monitoring windows 725 may be configured such that a time gap 735 (between a LP-WUS occasion 715 and a start of a PDCCH monitoring window 725) satisfies one or more of the supported multiple minimum time gap values.

Accordingly, the UE 115-a may use the LP-WUR 710-b to monitor the plurality of LP-WUS occasions 715 for one or more LP-WUSs 730. The UE 115-a may detect a LP-WUS 730 during the second LP-WUS occasion 715-b. The LP-WUS 730 may trigger the UE 115-a to receive the wake-up indication 745, which may cause the UE 115-a to ramp-up power of the MR 710-a to transition the MR 710-a from a sleep state, such as a deep sleep state, to a wake state, during the time gap 735. Accordingly, the UE 115-a may have sufficient time to transition the MR 710-a to the wake state in order to monitor the next PDCCH monitoring window 725-b using the MR 710-a.

Accordingly, the UE 115-a may receive, using the MR 710-a and during the PDCCH monitoring window 725-b, a first PDCCH control message 740-a. In some instances, the UE 115-a may receive a plurality of PDCCH control messages 740 during one of the PDCCH monitoring windows 725. In some cases, when there is a threshold quantity of PDCCH control messages 740 being received during one of the PDCCH monitoring windows 725, the PDCCH monitoring window 725 may be extended. For instance, the network entity 105-a may signal, to the UE 115-a, an extension of one or more of the plurality of PDCCH monitoring windows 725, such as the second PDCCH monitoring window 725-b.

In some cases, however, extending the PDCCH monitoring window 725 may cause the UE 115-a to miss (e.g., not be able to monitor) one or more of the LP-WUS occasions 715. For example, if the second PDCCH monitoring window 725-b is extended, the UE 115-a may miss the third LP-WUS occasion 715-c. In some cases, missing a LP-WUS occasion 715 may mean that there is no LP-WUS occasion 715 for receiving a LP-WUS 730 in advance of a next PDCCH monitoring window 725. For example, missing the third LP-WUS occasion 715-c may mean that there is no LP-WUS occasion 715 for receiving a LP-WUS 730 to signal the UE 115-a to wake-up its MR 710-a to monitor the third PDCCH monitoring window 725-c for a PDCCH control message 740. In such cases, rather than ramping power of the MR 710-a down after the extended PDCCH monitoring window 725 ends to transition the MR 710-a to the sleep state, the UE 115-a may instead ramp-down the power only partially, such as to transition the MR 710-a to a state that may enable the MR 710-a to quickly ramp back up in time for a next PDCCH monitoring window 725. For example, after the second PDCCH monitoring window 725-b ends, the UE 115-a may partially ramp-down the power of the MR 710-a to transition the MR 710-a to a light sleep state. Thereafter, and at a time prior to a start of the next PDCCH monitoring window 725, such as the third PDCCH monitoring window 725-c, the UE 115-b may ramp-up the power of the MR 710-a to transition the MR 710-a from the light sleep state to a wake state in sufficient time to monitor the third PDCCH monitoring window 725-c. The UE 115-a may then monitor the third PDCCH monitoring window 725-c as using the MR 710-a if the UE 115-a were triggered by a LP-WUS 730. Accordingly, the UE 115-a may receive, using the MR 510-a and during the third PDCCH monitoring window 725-c, a second PDCCH control message 740-b. In some cases, after the PDCCH monitoring window 725-c ends (e.g., when the PDCCH monitoring window 725 is not an extended PDCCH monitoring window 725), the UE 115-a may ramp-down power of the MR 710-a to transition the MR 710-a back to the sleep state. The UE 115-a may then use the LP-WUR 710-b to monitor for further LP-WUSs 730.

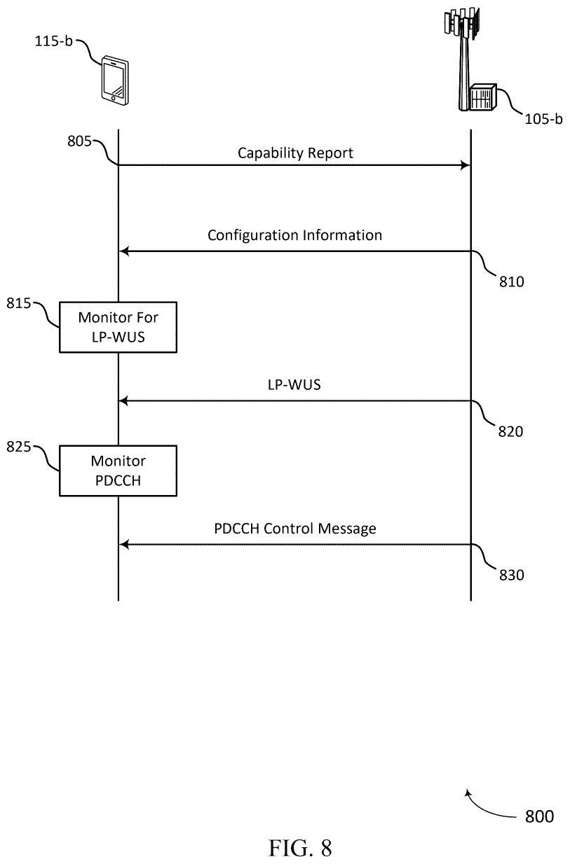

FIG. 8 shows an example of a signal flow 800 that supports minimum time gaps for LP-WUSs in accordance with one or more aspects of the present disclosure. In some aspects, the signal flow 800 may be implemented by aspects of the wireless communications systems 100 and 200, as described with reference to FIGS. 1 and 2, time gap configurations 300, 400-a, and 400-b, as described with reference to FIGS. 3, 4A, and 4B, and LP-WUS designs 500, 600, and 700, as described with reference to FIGS. 5, 6, and 7. The signal flow 800 may illustrate the flow of signals between a UE 115-b and a network entity 105-b. In the following description of the signal flow 800, the communications between the UE 115-b and the network entity 105-b may be transmitted in a different order than the order shown, or the operations performed by the UE 115-b and the network entity 105-b may be performed in different orders or at different times. Some operations may also be omitted from the signal flow 800, and other operations may be added to the signal flow 800. In some aspects, the operations illustrated in signal flow 800 may be performed by hardware (e.g., including circuitry, processing blocks, logic components, and other components), code (e.g., software or firmware) executed by a processor, or any combination thereof. Alternatively, some steps may be performed in a different order than described or might not be performed at all. In some cases, steps may include additional features not mentioned below, or further steps may be added.

In some cases, the UE 115-b may turn off its MR (e.g., transition the MR to a sleep state) and switch to its LP-WUR to operate in a low-power mode in order to save power. The UE 115-b may use the LP-WUR to monitor for one or more LP-WUSs.

At 805, the UE 115-b may transmit, and the network entity 105-b may receive, a capability report that indicates a capability of the UE 115-b to support one or more minimum time gap values. For instance, the capability report may include an indication of a first supported minimum time gap value and of a second supported minimum time gap value, where the first supported minimum time gap value may be greater than the second supported minimum time gap value. In some cases, the one or more supported minimum time gap values may be selected from a plurality of candidate minimum time gap values. In some cases, the capability report may include an indication of a preferred one of the one or more supported minimum time gap values. In some cases the preferred minimum time gap value may be included in a separate, additional capability report.

At 810, the network entity 105-b may transmit, and the UE 115-b may receive, configuration information that indicates a time gap configuration. For instance, in response to receiving the capability report, the network entity 105-b may configure a plurality of LP-WUS occasions and a plurality of PDCCH monitoring windows. The network entity 105-b may configure the plurality of LP-WUS occasions and the plurality of PDCCH monitoring windows based on one or more of the multiple minimum time gaps supported by the UE 115-b and indicated in the capability report (or the additional capability report). The network entity 105-b may additionally configure one or more parameters that indicate a periodicity associated with the plurality of PDCCH monitoring windows, an offset associated with start locations of the plurality of PDCCH monitoring windows, a periodicity associated with the plurality of LP-WUS occasions, and an offset associated with start locations of the plurality of LP-WUS occasions. The network entity 105-b may configure the one or more parameters such that time gap between a LP-WUS occasion and a start of a next PDCCH monitoring window satisfies one or more of the supported multiple minimum time gap values. The network entity 105-b may determine which of the one or more supported multiple minimum time gap values is to be satisfied based on a rule associated with the time gap.

In some implementations, the time gap configuration may be semi-statically signaled to the UE 115-b. For instance, the network entity 105-b may transmit, to the UE 115-b and via RRC signaling, configuration information that indicates the plurality of LP-WUS occasions, the plurality of PDCCH monitoring windows, and the one or more parameters. In some cases, the configuration information may additionally include an indication of the time gap rule used by the network entity 105-b for configuring the time gap configuration, an indication of which of the one or more of the supported multiple minimum time gap values is effective, an indication of the currently effective time gap, or a combination there of. In some implementations, the network entity may transmit, to the UE 115-b and via L1/L2 signaling, configuration information that includes an indication of a currently effective time gap or corresponding time gap rule (such as to cause a switch of time gaps at the UE 115-b).

At 815, the UE 115-b may use the LP-WUR to monitor one or more of the plurality of LP-WUS occasions for a LP-WUS. For instance, the UE 115-b may receive, from the network entity 105-b, the configuration information and, in some cases, the UE 115-b may select which of the plurality of LP-WUS occasions to monitor for a LP-WUS based on the time gap rule or the time gap indicated in the configuration information. Accordingly, the UE 115-b may monitor the selected LP-WUS occasions. In some cases, at a time prior to a next LP-WUS occasion, the UE 115-b may perform an early ramp-up of power of the MR to transition the MR from a sleep state to a light state.

At 820, the network entity 105-b may transmit, and the UE 115-b may receive, a LP-WUS during the monitored LP-WUS occasion. The LP-WUS may trigger a wake-up indication at the UE 115-b, which may cause the UE 115-b to begin to ramp-up power of the MR to transition the MR from a sleep state (e.g., a deep sleep state or a light sleep state) to a wake state, during the configured time gap, so that the MR may be in the wake state to monitor a next PDCCH monitoring window.

At 825, the UE 115-b may use the MR to monitor the next PDCCH monitoring window for a PDCCH control message. The next PDCCH monitoring window may occur at a time after receipt of the LP-WUS that satisfies the configured time gap.

At 830, the network entity 105-b may transmit, and the UE 115-b may receive, during the monitored next PDCCH monitoring window, a PDCCH control message. In some cases, after an end of the PDCCH monitoring window, the UE 115-b may ramp-down the power of the MR to transition the MR back to the sleep state (e.g., such as deep sleep state or a light sleep state).

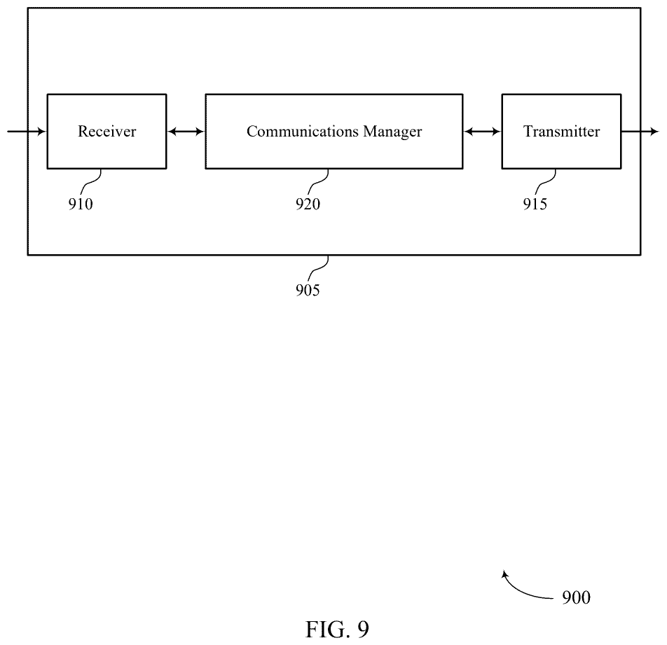

FIG. 9 shows a block diagram 900 of a device 905 that supports minimum time gaps for LP-WUSs in accordance with one or more aspects of the present disclosure. The device 905 may be an example of aspects of a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques.

Each of these components may be in communication with one another (e.g., via one or more buses).

The receiver 910 may provide a means for receiving information such as packets, user data, control information, or any combination thereof associated with various information channels (e.g., control channels, data channels, information channels related to minimum time gaps for LP-WUSs). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to minimum time gaps for LP-WUSs). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations or components thereof may be examples of means for performing various aspects of minimum time gaps for LP-WUSs as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for transmitting a capability report indicating a UE capability to support at least a first minimum time gap and a second minimum time gap of a set of multiple candidate minimum time gaps for PDCCH monitoring, where the first minimum time gap is larger than the second minimum time gap. The communications manager 920 is capable of, configured to, or operable to support a means for receiving first configuration information that is indicative of a set of multiple low power-wakeup signal (LP-WUS) occasions and a set of multiple PDCCH monitoring windows. The communications manager 920 is capable of, configured to, or operable to support a means for receiving a LP-WUS during a first LP-WUS occasion of the set of multiple LP-WUS occasions, where the LP-WUS is indicative that the UE is to monitor a first PDCCH monitoring window of the set of multiple PDCCH monitoring windows, where a time gap between the first LP-WUS occasion and the first PDCCH monitoring window satisfies one of the first minimum time gap or the second minimum time gap. The communications manager 920 is capable of, configured to, or operable to support a means for performing PDCCH monitoring during the first PDCCH monitoring window.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced power consumption.

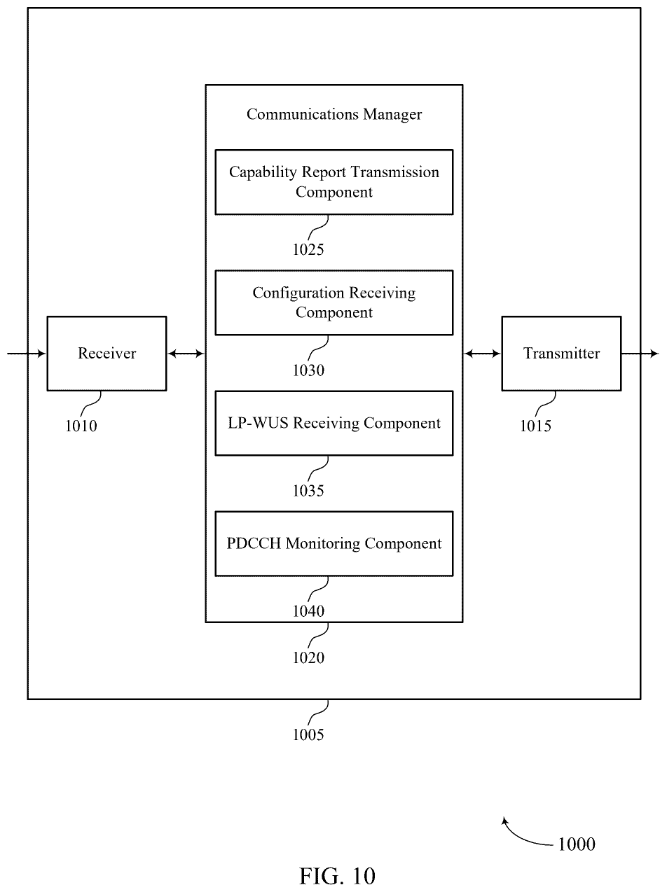

FIG. 10 shows a block diagram 1000 of a device 1005 that supports minimum time gaps for LP-WUSs in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005, or one of more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to minimum time gaps for LP-WUSs). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to minimum time gaps for LP-WUSs). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of minimum time gaps for LP-WUSs as described herein. For example, the communications manager 1020 may include a capability report transmission component 1025, a configuration receiving component 1030, a LP-WUS receiving component 1035, a PDCCH monitoring component 1040, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The capability report transmission component 1025 is capable of, configured to, or operable to support a means for transmitting a capability report indicating a UE capability to support at least a first minimum time gap and a second minimum time gap of a set of multiple candidate minimum time gaps for PDCCH monitoring, where the first minimum time gap is larger than the second minimum time gap. The configuration receiving component 1030 is capable of, configured to, or operable to support a means for receiving first configuration information that is indicative of a set of multiple low power-wakeup signal (LP-WUS) occasions and a set of multiple PDCCH monitoring windows. The LP-WUS receiving component 1035 is capable of, configured to, or operable to support a means for receiving a LP-WUS during a first LP-WUS occasion of the set of multiple LP-WUS occasions, where the LP-WUS is indicative that the UE is to monitor a first PDCCH monitoring window of the set of multiple PDCCH monitoring windows, where a time gap between the first LP-WUS occasion and the first PDCCH monitoring window satisfies one of the first minimum time gap or the second minimum time gap. The PDCCH monitoring component 1040 is capable of, configured to, or operable to support a means for performing PDCCH monitoring during the first PDCCH monitoring window.

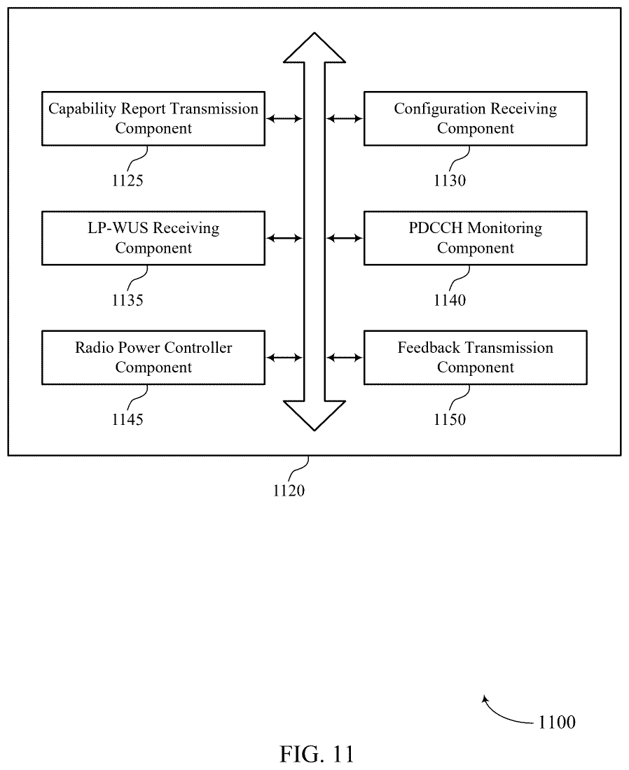

FIG. 11 shows a block diagram 1100 of a communications manager 1120 that supports minimum time gaps for LP-WUSs in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of minimum time gaps for LP-WUSs as described herein. For example, the communications manager 1120 may include a capability report transmission component 1125, a configuration receiving component 1130, a LP-WUS receiving component 1135, a PDCCH monitoring component 1140, a radio power controller component 1145, a feedback transmission component 1150, or any combination thereof. Each of these components, or components or subcomponents thereof (e.g., one or more processors, one or more memories), may communicate, directly or indirectly, with one another (e.g., via one or more buses).

The communications manager 1120 may support wireless communications in accordance with examples as disclosed herein. The capability report transmission component 1125 is capable of, configured to, or operable to support a means for transmitting a capability report indicating a UE capability to support at least a first minimum time gap and a second minimum time gap of a set of multiple candidate minimum time gaps for PDCCH monitoring, where the first minimum time gap is larger than the second minimum time gap. The configuration receiving component 1130 is capable of, configured to, or operable to support a means for receiving first configuration information that is indicative of a set of multiple low power-wakeup signal (LP-WUS) occasions and a set of multiple PDCCH monitoring windows. The LP-WUS receiving component 1135 is capable of, configured to, or operable to support a means for receiving a LP-WUS during a first LP-WUS occasion of the set of multiple LP-WUS occasions, where the LP-WUS is indicative that the UE is to monitor a first PDCCH monitoring window of the set of multiple PDCCH monitoring windows, where a time gap between the first LP-WUS occasion and the first PDCCH monitoring window satisfies one of the first minimum time gap or the second minimum time gap. The PDCCH monitoring component 1140 is capable of, configured to, or operable to support a means for performing PDCCH monitoring during the first PDCCH monitoring window.

In some examples, the time gap satisfies the first minimum time gap, and the radio power controller component 1145 is capable of, configured to, or operable to support a means for initializing a power ramp-up of a radio of the UE based on receipt of the LP-WUS in accordance with the first minimum time gap.

In some examples, the time gap satisfies the second minimum time gap and, to support does not satisfy the first minimum time gap, and where the method, the radio power controller component 1145 is capable of, configured to, or operable to support a means for initializing a power ramp-up of a radio of the UE based on a timing of the first PDCCH monitoring window. In some examples, the time gap satisfies the second minimum time gap and, to support does not satisfy the first minimum time gap, and where the method, the radio power controller component 1145 is capable of, configured to, or operable to support a means for continuing the power ramp-up of the radio based on receipt of the LP-WUS in accordance with the second minimum time gap.

In some examples, the time gap satisfies the second minimum time gap and, to support does not satisfy the first minimum time gap, and where the method, the radio power controller component 1145 is capable of, configured to, or operable to support a means for maintaining a radio of the UE in a power state that is able to be ramped-up during the second minimum time gap. In some examples, the time gap satisfies the second minimum time gap and, to support does not satisfy the first minimum time gap, and where the method, the radio power controller component 1145 is capable of, configured to, or operable to support a means for initializing a power ramp-up of the radio based on receipt of the LP-WUS in accordance with the second minimum time gap.

In some examples, the first configuration information includes one or more parameters that indicate a periodicity associated with the set of multiple PDCCH monitoring windows, an offset associated with start locations of the set of multiple PDCCH monitoring windows, a periodicity associated with the set of multiple LP-WUS occasions, an offset associated with start locations of the set of multiple LP-WUS occasions, or a combination thereof.

In some examples, the first configuration information includes one or more parameters that indicate the first PDCCH monitoring window as a next PDCCH monitoring window after the first LP-WUS occasion such that the time gap satisfies one of the first minimum time gap or the second minimum time gap.

In some examples, the first configuration information includes one or more parameters that indicate the first PDCCH monitoring window such that the first LP-WUS occasion precedes the first PDCCH monitoring window by the time gap in accordance with a rule. In some examples, the rule defines that the time gap satisfies one of the first minimum time gap or the second minimum time gap.

In some examples, the first configuration information includes one or more parameters that indicate the first LP-WUS occasion such that the first PDCCH monitoring window follows the first LP-WUS occasion by the time gap. In some examples, the time gap is one of the one or more parameters and satisfies one of the first minimum time gap or the second minimum time gap.

In some examples, the configuration receiving component 1130 is capable of, configured to, or operable to support a means for receiving, via L1 or L2 signaling, second configuration information that is indicative of a change in which of the first minimum time gap or the second minimum time gap is to be satisfied. In some examples, the LP-WUS receiving component 1135 is capable of, configured to, or operable to support a means for receiving a second LP-WUS during a second LP-WUS occasion of the set of multiple LP-WUS occasions, where the second LP-WUS is indicative that the UE is to monitor a second PDCCH monitoring window of the set of multiple PDCCH monitoring windows, where a second time gap between the second LP-WUS occasion and the second PDCCH monitoring window satisfies one of the first minimum time gap or the second minimum time gap in accordance with the second configuration information. In some examples, the PDCCH monitoring component 1140 is capable of, configured to, or operable to support a means for performing PDCCH monitoring during the second PDCCH monitoring window.

In some examples, the feedback transmission component 1150 is capable of, configured to, or operable to support a means for transmitting a feedback message indicating acknowledgement of the change indicated by the second configuration information.

In some examples, the L1 or L2 signaling includes medium access control-control element (MAC-CE) signaling or DCI signaling.

In some examples, the first configuration information is received via RRC signaling.

In some examples, the capability report transmission component 1125 is capable of, configured to, or operable to support a means for selecting, from among the first minimum time gap and the second minimum time gap, a preferred minimum time gap, where the capability report further indicates the preferred minimum time gap.

In some examples, the preferred minimum time gap is selected based on a channel condition, a battery power condition of the UE, usage of the UE, or a combination thereof.

In some examples, the PDCCH monitoring component 1140 is capable of, configured to, or operable to support a means for extending the first PDCCH monitoring window such that the first PDCCH monitoring window overlaps, in time, with a next LP-WUS occasion. In some examples, the radio power controller component 1145 is capable of, configured to, or operable to support a means for ramping-up or maintaining a power of a radio of the UE in order to perform PDCCH monitoring during a next PDCCH monitoring window associated with the next LP-WUS occasion, based on the first PDCCH monitoring window overlapping with the next LP-WUS occasion, which prevents the UE from using monitoring the next LP-WUS occasion.

In some examples, the LP-WUS is received using a first radio of the UE. In some examples, the PDCCH monitoring is performed using a second radio of the UE.

In some examples, the first radio is a low power-wakeup radio (LP-WUR) of the UE and the second radio is a main radio of the UE.

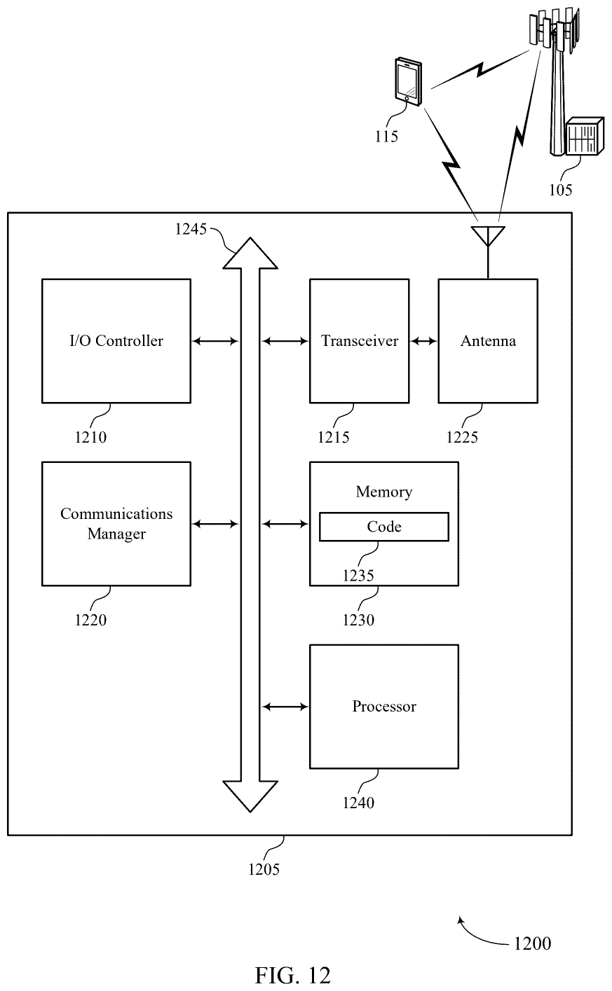

FIG. 12 shows a diagram of a system 1200 including a device 1205 that supports minimum time gaps for LP-WUSs in accordance with one or more aspects of the present disclosure. The device 1205 may be an example of or include components of a device 905, a device 1005, or a UE 115 as described herein. The device 1205 may communicate (e.g., wirelessly) with one or more other devices (e.g., network entities 105, UEs 115, or a combination thereof). The device 1205 may include components for bi-directional voice and data communications including components for transmitting and receiving communications, such as a communications manager 1220, an input/output (I/O) controller, such as an I/O controller 1210, a transceiver 1215, one or more antennas 1225, at least one memory 1230, code 1235, and at least one processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of one or more processors, such as the at least one processor 1240. In some cases, a user may interact with the device 1205 via the I/O controller 1210 or via hardware components controlled by the I/O controller 1210.

In some cases, the device 1205 may include a single antenna. However, in some other cases, the device 1205 may have more than one antenna, which may be capable of concurrently transmitting or receiving multiple wireless transmissions. The transceiver 1215 may communicate bi-directionally via the one or more antennas 1225 using wired or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The at least one memory 1230 may include random access memory (RAM) and read-only memory (ROM). The at least one memory 1230 may store computer-readable, computer-executable, or processor-executable code, such as the code 1235. The code 1235 may include instructions that, when executed by the at least one processor 1240, cause the device 1205 to perform various functions described herein. The code 1235 may be stored in a non-transitory computer-readable medium such as system memory or another type of memory. In some cases, the code 1235 may not be directly executable by the at least one processor 1240 but may cause a computer (e.g., when compiled and executed) to perform functions described herein. In some cases, the at least one memory 1230 may include, among other things, a basic I/O system (BIOS) which may control basic hardware or software operation such as the interaction with peripheral components or devices.

The at least one processor 1240 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1240 may be configured to operate a memory array using a memory controller. In some other cases, a memory controller may be integrated into the at least one processor 1240. The at least one processor 1240 may be configured to execute computer-readable instructions stored in a memory (e.g., the at least one memory 1230) to cause the device 1205 to perform various functions (e.g., functions or tasks supporting minimum time gaps for LP-WUSs). For example, the device 1205 or a component of the device 1205 may include at least one processor 1240 and at least one memory 1230 coupled with or to the at least one processor 1240, the at least one processor 1240 and the at least one memory 1230 configured to perform various functions described herein.

In some examples, the at least one processor 1240 may include multiple processors and the at least one memory 1230 may include multiple memories. One or more of the multiple processors may be coupled with one or more of the multiple memories, which may, individually or collectively, be configured to perform various functions described herein. In some examples, the at least one processor 1240 may be a component of a processing system, which may refer to a system (such as a series) of machines, circuitry (including, for example, one or both of processor circuitry (which may include the at least one processor 1240) and memory circuitry (which may include the at least one memory 1230)), or components, that receives or obtains inputs and processes the inputs to produce, generate, or obtain a set of outputs. The processing system may be configured to perform one or more of the functions described herein. For example, the at least one processor 1240 or a processing system including the at least one processor 1240 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code 1235 (e.g., processor-executable code) stored in the at least one memory 1230 or otherwise, to perform one or more of the functions described herein.

The communications manager 1220 may support wireless communications in accordance with examples as disclosed herein. For example, the communications manager 1220 is capable of, configured to, or operable to support a means for transmitting a capability report indicating a UE capability to support at least a first minimum time gap and a second minimum time gap of a set of multiple candidate minimum time gaps for PDCCH monitoring, where the first minimum time gap is larger than the second minimum time gap. The communications manager 1220 is capable of, configured to, or operable to support a means for receiving first configuration information that is indicative of a set of multiple low power-wakeup signal (LP-WUS) occasions and a set of multiple PDCCH monitoring windows. The communications manager 1220 is capable of, configured to, or operable to support a means for receiving a LP-WUS during a first LP-WUS occasion of the set of multiple LP-WUS occasions, where the LP-WUS is indicative that the UE is to monitor a first PDCCH monitoring window of the set of multiple PDCCH monitoring windows, where a time gap between the first LP-WUS occasion and the first PDCCH monitoring window satisfies one of the first minimum time gap or the second minimum time gap. The communications manager 1220 is capable of, configured to, or operable to support a means for performing PDCCH monitoring during the first PDCCH monitoring window.

By including or configuring the communications manager 1220 in accordance with examples as described herein, the device 1205 may support techniques for reduced latency, reduced power consumption, and longer battery life.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the at least one processor 1240, the at least one memory 1230, the code 1235, or any combination thereof. For example, the code 1235 may include instructions executable by the at least one processor 1240 to cause the device 1205 to perform various aspects of minimum time gaps for LP-WUSs as described herein, or the at least one processor 1240 and the at least one memory 1230 may be otherwise configured to, individually or collectively, perform or support such operations.

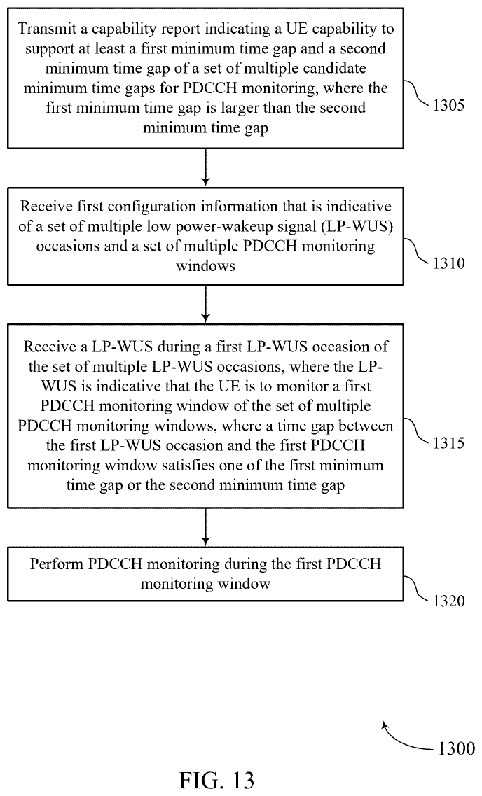

FIG. 13 shows a flowchart illustrating a method 1300 that supports minimum time gaps for LP-WUSs in accordance with one or more aspects of the present disclosure. The operations of the method 1300 may be implemented by a UE or its components as described herein. For example, the operations of the method 1300 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1305, the method may include transmitting a capability report indicating a UE capability to support at least a first minimum time gap and a second minimum time gap of a set of multiple candidate minimum time gaps for PDCCH monitoring, where the first minimum time gap is larger than the second minimum time gap. The operations of 1305 may be performed in accordance with examples as disclosed herein. In some examples, aspects of the operations of 1305 may be performed by a capability report transmission component 1125 as described with reference to FIG. 11.

At 1310, the method may include receiving first configuration information that is indicative of a set of multiple low power-wakeup signal (LP-WUS) occasions and a set of multiple PDCCH monitoring windows. The operations of 1310 may be performed in accordance with examples as disclosed herein. In some examples, aspects of the operations of 1310 may be performed by a configuration receiving component 1130 as described with reference to FIG. 11.

At 1315, the method may include receiving a LP-WUS during a first LP-WUS occasion of the set of multiple LP-WUS occasions, where the LP-WUS is indicative that the UE is to monitor a first PDCCH monitoring window of the set of multiple PDCCH monitoring windows, where a time gap between the first LP-WUS occasion and the first PDCCH monitoring window satisfies one of the first minimum time gap or the second minimum time gap. The operations of 1315 may be performed in accordance with examples as disclosed herein. In some examples, aspects of the operations of 1315 may be performed by a LP-WUS receiving component 1135 as described with reference to FIG. 11.

At 1320, the method may include performing PDCCH monitoring during the first PDCCH monitoring window. The operations of 1320 may be performed in accordance with examples as disclosed herein. In some examples, aspects of the operations of 1320 may be performed by a PDCCH monitoring component 1140 as described with reference to FIG. 11.

The following provides an overview of aspects of the present disclosure:

Aspect 1: A method for wireless communications by a UE, comprising: transmitting a capability report indicating a UE capability to support at least a first minimum time gap and a second minimum time gap of a plurality of candidate minimum time gaps for PDCCH monitoring, wherein the first minimum time gap is larger than the second minimum time gap; receiving first configuration information that is indicative of a plurality of LP-WUS occasions and a plurality of PDCCH monitoring windows; receiving a LP-WUS during a first LP-WUS occasion of the plurality of LP-WUS occasions, wherein the LP-WUS is indicative that the UE is to monitor a first PDCCH monitoring window of the plurality of PDCCH monitoring windows, wherein a time gap between the first LP-WUS occasion and the first PDCCH monitoring window satisfies one of the first minimum time gap or the second minimum time gap; and performing PDCCH monitoring during the first PDCCH monitoring window.

Aspect 2: The method of aspect 1, wherein the time gap satisfies the first minimum time gap, and wherein the method further comprises: initializing a power ramp-up of a radio of the UE based on receipt of the LP-WUS in accordance with the first minimum time gap.

Aspect 3: The method of any of aspects 1 through 2, wherein the time gap satisfies the second minimum time gap and does not satisfy the first minimum time gap, and wherein the method further comprises: initializing a power ramp-up of a radio of the UE based on a timing of the first PDCCH monitoring window; and continuing the power ramp-up of the radio based on receipt of the LP-WUS in accordance with the second minimum time gap.

Aspect 4: The method of any of aspects 1 through 3, wherein the time gap satisfies the second minimum time gap and does not satisfy the first minimum time gap, and wherein the method further comprises: maintaining a radio of the UE in a power state that is able to be ramped-up during the second minimum time gap; and initializing a power ramp-up of the radio based on receipt of the LP-WUS in accordance with the second minimum time gap.

Aspect 5: The method of any of aspects 1 through 4, wherein the first configuration information includes one or more parameters that indicate a periodicity associated with the plurality of PDCCH monitoring windows, an offset associated with start locations of the plurality of PDCCH monitoring windows, a periodicity associated with the plurality of LP-WUS occasions, an offset associated with start locations of the plurality of LP-WUS occasions, or a combination thereof.

Aspect 6: The method of any of aspects 1 through 5, wherein the first configuration information includes one or more parameters that indicate the first PDCCH monitoring window as a next PDCCH monitoring window after the first LP-WUS occasion such that the time gap satisfies one of the first minimum time gap or the second minimum time gap.

Aspect 7: The method of any of aspects 1 through 6, wherein the first configuration information includes one or more parameters that indicate the first PDCCH monitoring window such that the first LP-WUS occasion precedes the first PDCCH monitoring window by the time gap in accordance with a rule, the rule defines that the time gap satisfies one of the first minimum time gap or the second minimum time gap.

Aspect 8: The method of any of aspects 1 through 7, wherein the first configuration information includes one or more parameters that indicate the first LP-WUS occasion such that the first PDCCH monitoring window follows the first LP-WUS occasion by the time gap, the time gap is one of the one or more parameters and satisfies one of the first minimum time gap or the second minimum time gap.

Aspect 9: The method of any of aspects 1 through 8, further comprising: receiving, via L1 or L2 signaling, second configuration information that is indicative of a change in which of the first minimum time gap or the second minimum time gap is to be satisfied; receiving a second LP-WUS during a second LP-WUS occasion of the plurality of LP-WUS occasions, wherein the second LP-WUS is indicative that the UE is to monitor a second PDCCH monitoring window of the plurality of PDCCH monitoring windows, wherein a second time gap between the second LP-WUS occasion and the second PDCCH monitoring window satisfies one of the first minimum time gap or the second minimum time gap in accordance with the second configuration information; and performing PDCCH monitoring during the second PDCCH monitoring window.

Aspect 10: The method of aspect 9, further comprising: transmitting a feedback message indicating acknowledgement of the change indicated by the second configuration information.

Aspect 11: The method of any of aspects 9 through 10, wherein the L1 or L2 signaling comprises MAC-CE signaling or DCI signaling.

Aspect 12: The method of any of aspects 1 through 11, wherein the first configuration information is received via RRC signaling.

Aspect 13: The method of any of aspects 1 through 12, further comprising: selecting, from among the first minimum time gap and the second minimum time gap, a preferred minimum time gap, wherein the capability report further indicates the preferred minimum time gap.

Aspect 14: The method of aspect 13, wherein the preferred minimum time gap is selected based at least in part on a channel condition, a battery power condition of the UE, usage of the UE, or a combination thereof.

Aspect 15: The method of any of aspects 1 through 14, further comprising: extending the first PDCCH monitoring window such that the first PDCCH monitoring window overlaps, in time, with a next LP-WUS occasion; and ramping-up or maintaining a power of a radio of the UE in order to perform PDCCH monitoring during a next PDCCH monitoring window associated with the next LP-WUS occasion, based at least in part on the first PDCCH monitoring window overlapping with the next LP-WUS occasion, which prevents the UE from using monitoring the next LP-WUS occasion.

Aspect 16: The method of any of aspects 1 through 15, wherein the LP-WUS is received using a first radio of the UE, and the PDCCH monitoring is performed using a second radio of the UE.

Aspect 17: The method of aspect 16, wherein the first radio is a LP-WUR of the UE and the second radio is a main radio of the UE.

Aspect 18: A UE for wireless communications, comprising one or more memories storing processor-executable code, and one or more processors coupled with the one or more memories and individually or collectively operable to execute the code to cause the UE to perform a method of any of aspects 1 through 17.

Aspect 19: A UE for wireless communications, comprising at least one means for performing a method of any of aspects 1 through 17.

Aspect 20: A non-transitory computer-readable medium storing code for wireless communications, the code comprising instructions executable by one or more processors to perform a method of any of aspects 1 through 17.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, a NPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit a capability report indicating a UE capability to support at least a first minimum time gap and a second minimum time gap of a plurality of candidate minimum time gaps for physical downlink control channel (PDCCH) monitoring, wherein the first minimum time gap is larger than the second minimum time gap;
receive first configuration information that is indicative of a plurality of low power-wakeup signal (LP-WUS) occasions and a plurality of PDCCH monitoring windows;
receive a LP-WUS during a first LP-WUS occasion of the plurality of LP-WUS occasions, wherein the LP-WUS is indicative that the UE is to monitor a first PDCCH monitoring window of the plurality of PDCCH monitoring windows, wherein a time gap between the first LP-WUS occasion and the first PDCCH monitoring window satisfies one of the first minimum time gap or the second minimum time gap; and
perform PDCCH monitoring during the first PDCCH monitoring window.

2. The UE of claim 1, wherein the time gap satisfies the first minimum time gap, and the one or more processors are individually or collectively further operable to execute the code to cause the UE to:
initialize a power ramp-up of a radio of the UE based on receipt of the LP-WUS in accordance with the first minimum time gap.

3. The UE of claim 1, wherein the time gap satisfies the second minimum time gap, and, to do not satisfy the first minimum time gap, and wherein the one or more processors are individually or collectively further operable to execute the code to cause the UE to:
initialize a power ramp-up of a radio of the UE based on a timing of the first PDCCH monitoring window; and
continue the power ramp-up of the radio based on receipt of the LP-WUS in accordance with the second minimum time gap.

4. The UE of claim 1, wherein the time gap satisfies the second minimum time gap and does not satisfy the first minimum time gap, and wherein the one or more processors are individually or collectively further operable to execute the code to cause the UE to:
maintain a radio of the UE in a power state that is able to be ramped-up during the second minimum time gap; and
initialize a power ramp-up of the radio based on receipt of the LP-WUS in accordance with the second minimum time gap.

5. The UE of claim 1, wherein the first configuration information includes one or more parameters that indicate a periodicity associated with the plurality of PDCCH monitoring windows, an offset associated with start locations of the plurality of PDCCH monitoring windows, a periodicity associated with the plurality of LP-WUS occasions, an offset associated with start locations of the plurality of LP-WUS occasions, or a combination thereof.

6. The UE of claim 1, wherein the first configuration information includes one or more parameters that indicate the first PDCCH monitoring window as a next PDCCH monitoring window after the first LP-WUS occasion such that the time gap satisfies one of the first minimum time gap or the second minimum time gap.

7. The UE of claim 1, wherein the first configuration information includes one or more parameters that indicate the first PDCCH monitoring window such that the first LP-WUS occasion precedes the first PDCCH monitoring window by the time gap in accordance with a rule, and wherein the rule defines that the time gap satisfies one of the first minimum time gap or the second minimum time gap.

8. The UE of claim 1, wherein the first configuration information includes one or more parameters that indicate the first LP-WUS occasion such that the first PDCCH monitoring window follows the first LP-WUS occasion by the time gap, and wherein the time gap is one of the one or more parameters and satisfies one of the first minimum time gap or the second minimum time gap.

9. The UE of claim 1, wherein the one or more processors are individually or collectively further operable to execute the code to cause the UE to:
receive, via L1 or L2 signaling, second configuration information that is indicative of a change in which of the first minimum time gap or the second minimum time gap is to be satisfied;
receive a second LP-WUS during a second LP-WUS occasion of the plurality of LP-WUS occasions, wherein the second LP-WUS is indicative that the UE is to monitor a second PDCCH monitoring window of the plurality of PDCCH monitoring windows, wherein a second time gap between the second LP-WUS occasion and the second PDCCH monitoring window satisfies one of the first minimum time gap or the second minimum time gap in accordance with the second configuration information; and
perform PDCCH monitoring during the second PDCCH monitoring window.

10. The UE of claim 9, wherein the one or more processors are individually or collectively further operable to execute the code to cause the UE to:
transmit a feedback message indicating acknowledgement of the change indicated by the second configuration information.

11. The UE of claim 9, wherein the L1 or L2 signaling comprises medium access control-control element (MAC-CE) signaling or downlink control information (DCI) signaling.

12. The UE of claim 1, wherein the first configuration information is received via radio resource control (RRC) signaling.

13. The UE of claim 1, wherein the one or more processors are individually or collectively further operable to execute the code to cause the UE to:
select, from among the first minimum time gap and the second minimum time gap, a preferred minimum time gap, wherein the capability report further indicates the preferred minimum time gap.

14. The UE of claim 13, wherein the preferred minimum time gap is selected based at least in part on a channel condition, a battery power condition of the UE, usage of the UE, or a combination thereof.

15. The UE of claim 1, wherein the one or more processors are individually or collectively further operable to execute the code to cause the UE to:
extend the first PDCCH monitoring window such that the first PDCCH monitoring window overlaps, in time, with a next LP-WUS occasion; and
ramping-up or maintain a power of a radio of the UE in order to perform PDCCH monitoring during a next PDCCH monitoring window associated with the next LP-WUS occasion, based at least in part on the first PDCCH monitoring window overlapping with the next LP-WUS occasion, which prevents the UE from using monitoring the next LP-WUS occasion.

16. The UE of claim 1, wherein:
the LP-WUS is received using a first radio of the UE, and
the PDCCH monitoring is performed using a second radio of the UE.

17. A method for wireless communications by a user equipment (UE), comprising:
transmitting a capability report indicating a UE capability to support at least a first minimum time gap and a second minimum time gap of a plurality of candidate minimum time gaps for physical downlink control channel (PDCCH) monitoring, wherein the first minimum time gap is larger than the second minimum time gap;
receiving first configuration information that is indicative of a plurality of low power-wakeup signal (LP-WUS) occasions and a plurality of PDCCH monitoring windows;
receiving a LP-WUS during a first LP-WUS occasion of the plurality of LP-WUS occasions, wherein the LP-WUS is indicative that the UE is to monitor a first PDCCH monitoring window of the plurality of PDCCH monitoring windows, wherein a time gap between the first LP-WUS occasion and the first PDCCH monitoring window satisfies one of the first minimum time gap or the second minimum time gap; and
performing PDCCH monitoring during the first PDCCH monitoring window.

18. The method of claim 17, wherein the time gap satisfies the first minimum time gap, and wherein the method further comprises:
initializing a power ramp-up of a radio of the UE based on receipt of the LP-WUS in accordance with the first minimum time gap.

19. The method of claim 17, wherein the time gap satisfies the second minimum time gap and does not satisfy the first minimum time gap, and wherein the method further comprises:
initializing a power ramp-up of a radio of the UE based on a timing of the first PDCCH monitoring window; and
continuing the power ramp-up of the radio based on receipt of the LP-WUS in accordance with the second minimum time gap.

20. A non-transitory computer-readable medium storing code for wireless communications, the code comprising instructions executable by one or more processors of a user equipment (UE) to:
transmit a capability report indicating a UE capability to support at least a first minimum time gap and a second minimum time gap of a plurality of candidate minimum time gaps for physical downlink control channel (PDCCH) monitoring, wherein the first minimum time gap is larger than the second minimum time gap;
receive first configuration information that is indicative of a plurality of low power-wakeup signal (LP-WUS) occasions and a plurality of PDCCH monitoring windows;
receive a LP-WUS during a first LP-WUS occasion of the plurality of LP-WUS occasions, wherein the LP-WUS is indicative that the UE is to monitor a first PDCCH monitoring window of the plurality of PDCCH monitoring windows, wherein a time gap between the first LP-WUS occasion and the first PDCCH monitoring window satisfies one of the first minimum time gap or the second minimum time gap; and
perform PDCCH monitoring during the first PDCCH monitoring window.
